(19) United States
(12) Patent Application Publication
(10) Pub. No.: US 2019/0310082 A1
(43) Pub. Date: Oct. 10, 2019

(54) STRAIN CALCULATION APPARATUS, STRAIN COMPENSATION APPARATUS, PROGRAM, AND STORAGE MEDIUM

(71) Applicant: Mitsubishi Electric Corporation, Chiyoda-ku (JP)

(72) Inventors: Takashi IWAKURA, Chiyoda-ku (JP); Takayuki ISHIDA, Chiyoda-ku (JP)

(73) Assignee: Mitsubishi Electric Corporation, Chiyoda-ku (JP)

(21) Appl. No.: 16/461,232

(22) PCT Filed: Jan. 17, 2018
(86) PCT No.: PCT/JP2018/001212

§ 371 Date: May 15, 2019

(30) Foreign Application Priority Data
Jan. 27, 2017 (JP) 2017-013438

(51) Int. Cl. G01B 21/32; G05B 19/406; G05B 19/4155

(52) U.S. Cl. CPC G01B 21/32; G05B 2219/37274; G05B 19/4155; G05B 19/406

(57) ABSTRACT

A strain calculation apparatus (300) calculates strain in a structure (100) based on environment-versus-temperature information and temperature-versus-strain information. The environment-versus-temperature information associates environmental data affecting a temperature increase or decrease in the structure (100) at an installation location of the structure (100) with the temperature of the structure (100) acquired when the environmental data is acquired. The temperature-versus-strain information associates a temperature of the structure (100) with strain in the structure (100) at the temperature. The strain calculation apparatus (300) includes a temperature calculation unit (340) to calculate a temperature of the structure (100) based on the acquired environmental acquisition data and the environment-versus-temperature information, and a strain calculation unit (350) to calculate a strain in the structure (100) based on the temperature calculated by the temperature calculation unit (340) and the temperature-versus-strain information.

### TECHNICAL FIELD

The present disclosure relates to a strain calculation apparatus for calculating strain in a structure and a strain compensation apparatus for compensating for the strain.

### BACKGROUND ART

Outdoor structures such as large antennas and telescopes are maintained to retain specified shapes to meet performance requirements. However, such structures can have strain due to thermal expansion or deflection under self-weight. To compensate for strain, for example, Patent Literature 1 describes a technique for retaining the shape of a structure with a compensation mechanism that compensates for strain. The compensation mechanism involves accurate strain determination when used in a large structure. To measure strain in a structure, for example, Patent Literature 2 describes a technique for measuring the three-dimensional shape of a target using photogrammetry. However, this technique, when used for a large structure, involves large-scale equipment for installing a photogrammetry device. The installation of large-scale equipment can, for example, affect the directional characteristics of the antennas, and obstruct the field of view of a telescope. As a measuring technique without the need for large-scale equipment, for example, Patent Literature 3 describes a technique using an aerial vehicle carrying a photogrammetry device that flies for every measurement.

### CITATION LIST

### Patent Literature

### Patent Literature 1: Unexamined Japanese Patent Application Kokai Publication No. 2002-100551

### Patent Literature 2: Unexamined Japanese Patent Application Kokai Publication No. 2007-333508

### Patent Literature 3: Unexamined Japanese Patent Application Kokai Publication No. 2016-85100

### SUMMARY OF INVENTION

### Technical Problem

Measuring a structure using an aerial vehicle may involve determining a photographing location and a flight route, controlling the flight of the aerial vehicle, monitoring the aerial vehicle and the like, thus placing operational burdens when such strain measurement is performed frequently. Thus, the strain in a structure is to be determined at an accuracy that enables compensation, while keeping frequency of measurement to a minimum.

In response to the above issue, one or more aspects of the present disclosure are directed to a strain calculation apparatus and a strain compensation apparatus that determine strain in a structure with a reduced burden in measuring strain.

### Solution to Problem

A strain calculation apparatus according to an aspect of the present disclosure calculates strain in a structure based on environment-versus-temperature information and temperature-versus-strain information. The environment-versus-temperature information associates environmental data affecting a temperature increase or decrease in the structure with a temperature of the structure. The temperature-versus-strain information associates a temperature of the structure with a strain in the structure at the temperature. The strain calculation apparatus includes a temperature calculation unit to calculate a temperature of the structure based on environmental acquisition data representing the environmental data acquired at an installation location of the structure, and the environment-versus-temperature information, and a strain calculation unit to calculate a strain in the structure based on the temperature calculated by the temperature calculation unit and the temperature-versus-strain information. A strain compensation apparatus according to another aspect of the present disclosure includes the strain calculation apparatus described above.

### Advantageous Effects of Invention

The strain calculation apparatus and the strain compensation apparatus according to the above aspects of the present disclosure reduce the burden of strain measurement to determine strain in a structure.

### BRIEF DESCRIPTION OF DRAWINGS

FIG. 1 is a schematic diagram of a strain compensation apparatus according to Embodiment 1 of the present disclosure;

FIG. 2 is a flowchart illustrating an operation of the strain compensation apparatus according to Embodiment 1 of the present disclosure;

FIG. 3 is a flowchart illustrating an operation of a determination unit included in the strain compensation apparatus according to Embodiment 1 of the present disclosure;

FIG. 4 is a flowchart illustrating an operation of strain calculation based on environmental acquisition data and strain compensation performed by the strain compensation apparatus according to Embodiment 1 of the present disclosure;

FIG. 5 is a flowchart illustrating an operation of strain measurement and strain compensation performed by the strain compensation apparatus according to Embodiment 1 of the present disclosure;

FIG. 6A is a flowchart illustrating an operation of an aerial vehicle that provides measurement data to the strain compensation apparatus according to Embodiment 1 of the present disclosure;

FIG. 6B is a flowchart illustrating an operation of an observation device that provides measurement data to the strain compensation apparatus according to Embodiment 1 of the present disclosure;

FIG. 7 is a schematic diagram of a strain compensation apparatus according to Embodiment 2 of the present disclosure;

FIG. 8 is a flowchart illustrating an operation of a determination unit included in the strain compensation apparatus according to Embodiment 2 of the present disclosure;

FIG. 9 is a flowchart illustrating an operation of strain calculation based on environmental acquisition data and strain compensation performed by the strain compensation apparatus according to Embodiment 2 of the present disclosure;

FIG. 10 is a schematic diagram of a strain compensation apparatus according to Embodiment 3 of the present disclosure;

FIG. 11 is a flowchart illustrating an operation of the strain compensation apparatus according to Embodiment 3 of the present disclosure;

FIG. 12 is a flowchart illustrating an operation of a determination unit included in the strain compensation apparatus according to Embodiment 3 of the present disclosure;

FIG. 13 is a flowchart illustrating an operation of strain calculation based on a temperature measurement value and temperature-versus-strain data and strain compensation performed by the strain compensation apparatus according to Embodiment 3 of the present disclosure;

FIG. 14 is a schematic diagram of a strain compensation apparatus according to Embodiment 4 of the present disclosure;

FIG. 15 is a schematic diagram of a strain compensation apparatus according to Embodiment 5 of the present disclosure;

FIG. 16 is a flowchart illustrating an operation of strain calculation based on environmental acquisition data and strain compensation performed by the strain compensation apparatus according to Embodiment 5 of the present disclosure; and

FIG. 17 is a block diagram of the strain calculation apparatus or the strain compensation apparatus according to any of Embodiments 1 to 5 of the present disclosure illustrating an example hardware configuration of the apparatus.

### DESCRIPTION OF EMBODIMENTS

### Embodiment 1

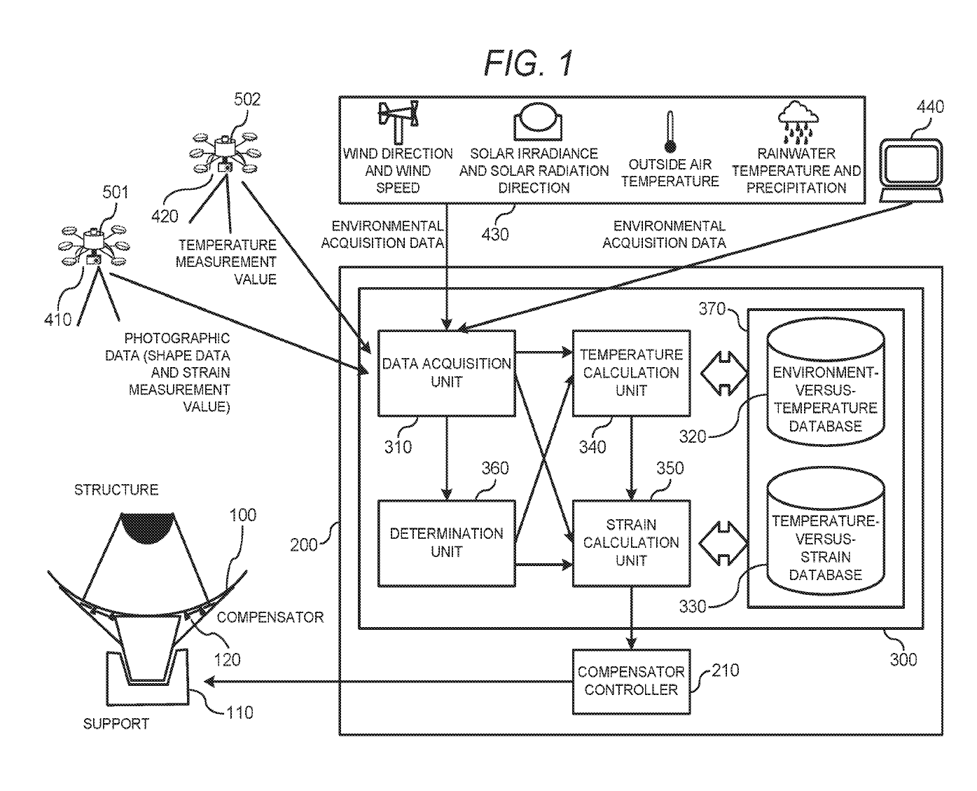

Embodiment 1 of the present disclosure is described next with reference to FIGS. 1 to 5 and FIGS. 6A and 6B. FIG. 1 is a schematic diagram of a strain compensation apparatus 200 according to Embodiment 1 of the present disclosure. A structure 100 is a target to undergo strain compensation. The structure 100 has a body supported on a support 110. The structure 100 includes a compensator 120 for compensating for strain in the structure 100. The strain compensation apparatus 200 determines strain in the structure 100, and controls the compensator 120 based on the determined strain to compensate for the strain in the structure 100. The compensator 120 includes, for example, an actuator that directly applies a force to the structure 100 to compensate for the strain, and a cooler that cools the structure 100 to compensate for the strain caused by thermal expansion of the structure 100. The compensator 120 is an example of a strain compensator of the present disclosure.

The strain compensation apparatus 200 includes a strain calculation apparatus 300 and a compensator controller 210. The strain calculation apparatus 300 determines strain in the structure 100 based on a strain measurement value of the structure 100 determined from a measurement result from a photogrammetry device 410 or based on an environmental data measurement value acquired by an observation device 430 or a value of environmental data acquired by an environmental data collector 440. The compensator controller 210 controls the compensator 120 based on the strain in the structure 100 determined by the strain calculation apparatus 300. In other words, the strain compensation apparatus 200 includes the strain calculation apparatus 300 to determine the strain in the structure 100. Thus, the strain calculation apparatus 300 is described herein in the manner applicable to strain determination performed by the strain compensation apparatus 200. Also, the strain determination performed by the strain compensation apparatus 200 is described in the manner applicable to the strain calculation apparatus 300.

The photogrammetry device 410 is carried by an aerial vehicle 501 to capture images of the structure 100 from the air. The aerial vehicle 501 carrying the photogrammetry device 410 flies along a predetermined flight route, thereby enabling the photogrammetry device 410 to capture images of the structure 100 from different locations. The photogrammetry device 410, which captures images of the structure 100 from different locations, transmits the photographic data acquired by capturing the images of the structure 100 to the strain compensation apparatus 200. The strain compensation apparatus 200 compares the images in the photographic data of the structure 100 captured from different locations to acquire shape data representing the three-dimensional shape of the structure 100. The shape data is further compared with a reference shape of the structure 100 to produce strain data representing strain in the structure 100. The shape data and the strain data may be calculated by the photogrammetry device 410 or the strain compensation apparatus 200 based on the measurement result from the photogrammetry device 410. The photogrammetry device 410 is an example of a strain sensor of the present disclosure.

A thermography device 420 measures temperature distribution in the structure 100 by analyzing infrared rays radiated from the structure 100. The thermography device 420 transmits the temperature distribution to the strain compensation apparatus 200 as temperature data. The thermography device 420 is carried by an aerial vehicle 502. The aerial vehicle 501 carrying the thermography device 420 flies along a predetermined flight route, thereby enabling the thermography device 420 to capture images of all the strained parts of the structure 100 to be compensated for. The photogrammetry device 410 and the thermography device 420, which are carried by different aerial vehicles (501 and 502) in FIG. 1, may be carried by the same single aerial vehicle. The thermography device 420 is an example of a temperature sensor of the present disclosure.

The observation device 430 measures environmental data that affects the temperature increase or decrease in the structure. The environmental data includes at least one of solar radiation data, heat exchange environmental data, outside air temperature data, or rainwater data. The solar radiation data includes solar irradiance and the direction of solar radiation (azimuth and elevation). The heat exchange environmental data includes wind condition data and outside air temperature data. The wind condition data includes a wind direction and a wind speed. The rainwater data includes a rainwater temperature and precipitation.

The observation device 430 measures the environmental data for the location at which the structure 100 is installed. When the environmental data includes the solar radiation data, the observation device 430 includes a sensor such as a pyranometer for measuring solar irradiance and a solar radiation direction (azimuth and elevation). When the environmental data includes heat exchange environmental data, the observation device 430 includes sensors such as an anemoscope and an anemometer for measuring a wind direction and a wind speed and a thermometer for measuring an outside air temperature. When the environmental data includes outside air temperature data, the observation device 430 includes a sensor such as a thermometer for measuring an outside air temperature. When the environmental data includes rainwater data, the observation device 430 includes sensors such as a rain gauge for measuring precipitation and a thermometer for measuring a rainwater temperature. The observation device 430 measures the environmental data and transmits the data to the strain calculation apparatus 300 as environmental acquisition data.

The environmental data collector 440 may acquire the environmental acquisition data in place of the observation device 430. The environmental data collector 440 acquires the environmental data at the installation location of the structure 100 based on publically-available data, for example, in print or online with a network. For example, the environmental data collector 440 acquires the environmental acquisition data in the manner described below. The environmental data collector 440 acquires solar radiation data, wind condition data, and outside air temperature data from publically-available weather information. The environmental data collector 440 acquires precipitation included in rainwater data from publically-available weather information. The environmental data collector 440 uses outside air temperature data acquired from the publically-available weather information as the rainwater temperature included in the rainwater data. In the example described below, the observation device 430 acquires the environmental acquisition data.

The strain calculation apparatus 300 calculates strain in the structure 100 from the environmental acquisition data based on environment-versus-temperature information, which associates the environmental data at the installation location of the structure 100 with the temperature of the structure 100 acquired when the environmental data is acquired, and temperature-versus-strain information, which associates the temperature of the structure 100 with the strain in the structure 100 at the temperature. The strain calculation apparatus 300 calculates the strain in the structure 100 from the environmental acquisition data without measuring the strain in the structure 100, thus reducing the operational burden of strain measurement. Calculation herein refers not only to calculating information based on certain information but also to referring to and directly using certain information. The same applies to the examples described below.

When the strain in the structure 100 cannot be calculated from the environmental acquisition data, the strain calculation apparatus 300 acquires a strain measurement value of the structure 100, which is determined based on a measurement value from the photogrammetry device 410. Therefore, the strain calculation apparatus 300 can determine the strain in the structure 100 regardless of the circumstances. The strain in the structure 100 cannot be calculated from the environmental acquisition data when the value representing the acquired environmental acquisition data is not associated with any temperature value in the environment-versus-temperature information, or when the acquired environmental acquisition data value is associated with a temperature value in the environment-versus-temperature information but the temperature value is not associated with a strain value in the temperature-versus-strain information.

The strain calculation apparatus 300, which acquires the strain measurement value, also acquires, from the thermography device 420, the temperature measurement value measured when the strain measurement value is measured. The strain calculation apparatus 300 associates the strain measurement value with the temperature measurement value, and adds the associated values to the temperature-versus-strain information. In the same manner, the environmental acquisition data and the temperature measurement value acquired from the thermography device 420 are associated with each other and added to the environment-versus-temperature information. In this manner, the strain calculation apparatus 300 can calculate the strain in the structure 100 from the environmental acquisition data without measuring the strain in the structure 100 when the same environmental acquisition data or the same temperature of the structure 100 is acquired again.

As illustrated in FIG. 1, the strain calculation apparatus 300 includes a data acquisition unit 310, an environment-versus-temperature database 320, a temperature-versus-strain database 330, a temperature calculation unit 340, a strain calculation unit 350, and a determination unit 360.

The data acquisition unit 310 acquires a temperature measurement value of the structure 100 from the thermography device 420 and environmental acquisition data from the observation device 430. The data acquisition unit 310 also acquires a strain measurement value of the structure 100 determined based on photographic data captured by the photogrammetry device 410.

Data and information contained in the environment-versus-temperature database 320 and the temperature-versus-strain database 330 are stored in a storage 370. In FIG. 1, the data and information contained in the environment-versus-temperature database 320 and the temperature-versus-strain database 330 are both stored in the same storage 370. However, the environment-versus-temperature database 320 and the temperature-versus-strain database 330 may be stored in different storages. For example, the data and information contained in the environment-versus-temperature database 320 may be stored in an environment-versus-temperature storage, and the data and information contained in the temperature-versus-strain database 330 may be stored in a temperature-versus-strain storage. The storage 370, the environment-versus-temperature storage, and the temperature-versus-strain storage may be included in the strain calculation apparatus 300 as illustrated in FIG. 1, or may be included in an external server connected to the strain calculation apparatus 300. The storage 370 may be, for example, a virtual storage distributed across a network, as long as the storage 370 is at least writable and readable by the strain calculation apparatus 300.

The environment-temperature database 320 is an example of the environment-temperature information in the strain compensation apparatus 200. The environmental data is associated with the temperature of the structure 100 measured when the environmental data is acquired, by the environment-temperature database 320 storing environmental data with the temperature of the structure 100 measured when the environmental data is acquired, in an manner associated with each other. The temperature-versus-strain database 330 is an example of the temperature-versus-strain information in the strain compensation apparatus 200. A temperature of the structure 100 is associated with the strain in the structure 100 at that temperature by the temperature-versus-strain database 330 storing the temperature value of the structure 100 acquired by measurement or another method and the strain value of the structure 100 acquired when the temperature value is obtained, in a manner associated with each other.

The structure 100 that is installed outdoors is warmed by solar radiation in sunny conditions and is cooled by wind. The solar radiation data influences where the structure 100 is warmed and the extent to which the solar radiation warms the affected part.

In windy conditions, the heat is exchanged between the structure 100 and wind. When the temperature of the structure 100 is higher than the outside air temperature, heat transfers more from the structure 100 to wind than from wind to the structure 100. The temperature of the structure thus decreases. When the temperature of the structure 100 is lower than the outside air temperature, heat transfers less from the structure 100 to wind than from wind to the structure 100. The temperature of the structure 100 thus increases. Heat exchange environmental data including the wind condition data and the outside air temperature data influences where the structure 100 undergoes a temperature increase or decrease through heat exchange with wind and influences the extent to which the temperature increases or decreases.

When the temperature difference between the structure 100 and the outside air is large, the temperature of the structure 100 increases or decreases depending on the relationship between the heat radiated from the structure 100 into the outside air and the heat radiated from the outside air to the structure 100. When the temperature of the structure 100 is higher than the outside air temperature, the heat radiated from the structure 100 into the outside air is greater than the heat absorbed by the structure 100 due to the heat radiated by the outside air. The temperature of the structure 100 thus decreases. When the temperature of the structure 100 is lower than the outside air temperature, the heat radiated from the structure 100 into the outside air is less than the heat absorbed by the structure 100 due to the heat radiated by the outside air. The temperature of the structure 100 thus increases. The rate of the temperature increase or decrease in the structure 100 depends on the outside air temperature data.

In rainy conditions, the heat is exchanged between the structure 100 and rainwater. When the temperature of the structure 100 is higher than the rainwater temperature, heat transfers more from the structure 100 to rainwater than from rainwater to the structure 100. The temperature of the structure 100 thus decreases. When the temperature of the structure 100 is lower than the rainwater temperature, heat transfers less from the structure 100 to rainwater than from rainwater to the structure 100. The temperature of the structure 100 thus increases. The rate of the temperature increase or decrease in the structure 100 through heat exchange with rainwater depends on the rainwater data, including a rainwater temperature and precipitation.

In other words, the solar radiation data affects a temperature increase in the structure 100. The heat exchange environmental data affects a temperature increase or decrease in the structure 100. The outside air temperature data affects a temperature increase or decrease in the structure 100. The rainwater data affects a temperature increase or decrease in the structure 100. Thus, the temperature of the structure 100 can be estimated from the environmental data including solar radiation data, heat exchange environmental data, outside air temperature data, and rainwater data.

The temperature calculation unit 340 estimates the temperature of the structure 100 from the environmental acquisition data and the environment-versus-temperature information (environment-versus-temperature database 320) associating such environmental data with a temperature value of the structure 100. The structure 100 can deform due to gravity and thermal expansion. Given the constant influence of gravity, the strain in the structure 100 is determined by the temperature of the structure 100. The strain calculation unit 350 thus calculates the strain in the structure 100 from the temperature of the structure 100 estimated by the temperature calculation unit 340 and the temperature-versus-strain information (temperature-versus-strain database 330) associating the temperature of the structure 100 with the strain in the structure 100. The determination unit 360 determines whether the strain in the structure 100 can be determined from the acquired environmental acquisition data based on the environment-versus-temperature database 320 and the temperature-versus-strain database 330. More specifically, the determination unit 360 determines whether strain measurement data, which is acquirable based on a measurement result from the photogrammetry device 410, is to be acquired to determine the strain in the structure 100.

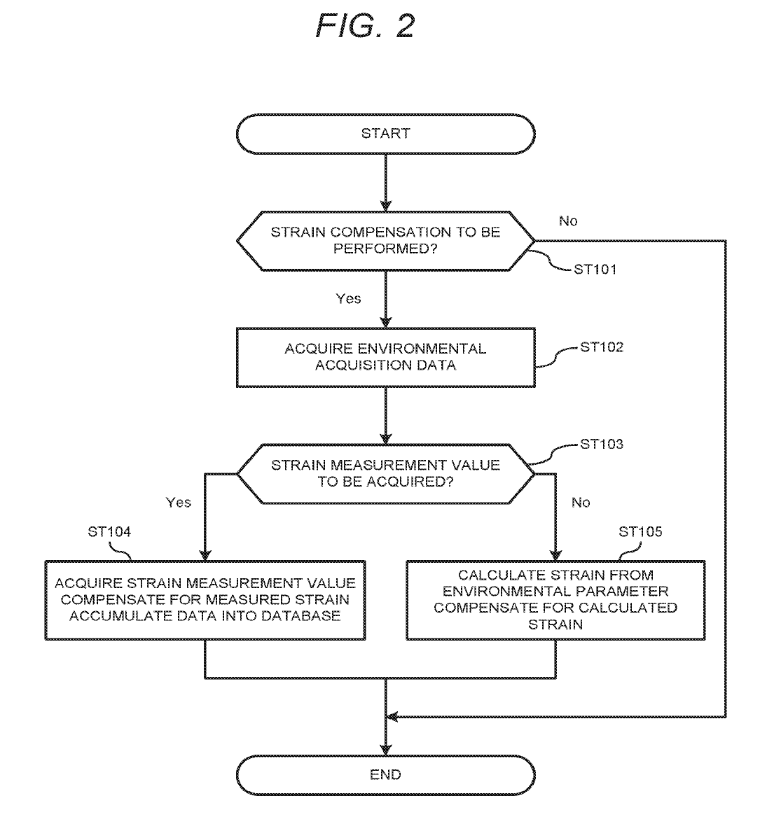

The operation is described next. FIG. 2 is a flowchart illustrating an operation of the strain compensation apparatus 200. The strain compensation apparatus 200 determines whether to perform strain compensation in response to changes in environmental data, operational requirements, and the like (ST101). When a determination is made that no strain compensation is to be performed (NO in ST101), the operation ends without compensation. When a determination is made that strain compensation is to be performed (YES in ST101), the data acquisition unit 310 acquires environmental acquisition data from the observation device 430 (ST102).

The determination unit 360 then determines whether the strain measurement value of the structure 100 is to be acquired based on the environmental acquisition data acquired by the data acquisition unit 310 (ST103). When a determination is made that the strain measurement value is to be acquired (YES in ST103), the data acquisition unit 310 acquires the strain measurement value determined based on the measurement result from the photogrammetry device 410. The strain calculation unit 350 determines the strain in the structure 100 by acquiring the strain measurement value from the data acquisition unit 310. The compensator controller 210 determines a control variable of the compensator 120 based on the strain determined by the strain calculation unit 350, and controls the compensator 120 in accordance with the determined control variable (ST104). When a determination is made that strain measurement is not to be performed (NO in ST103), the strain calculation unit 350 determines, based on the temperature-versus-strain database 330, the strain in the structure 100 from the temperature estimated by the temperature calculation unit 340 based on the environmental acquisition data and the environment-versus-temperature database 320. The compensator controller 210 controls the compensator 120 in accordance with a control variable calculated from the strain determined by the strain calculation unit 350 (ST105).

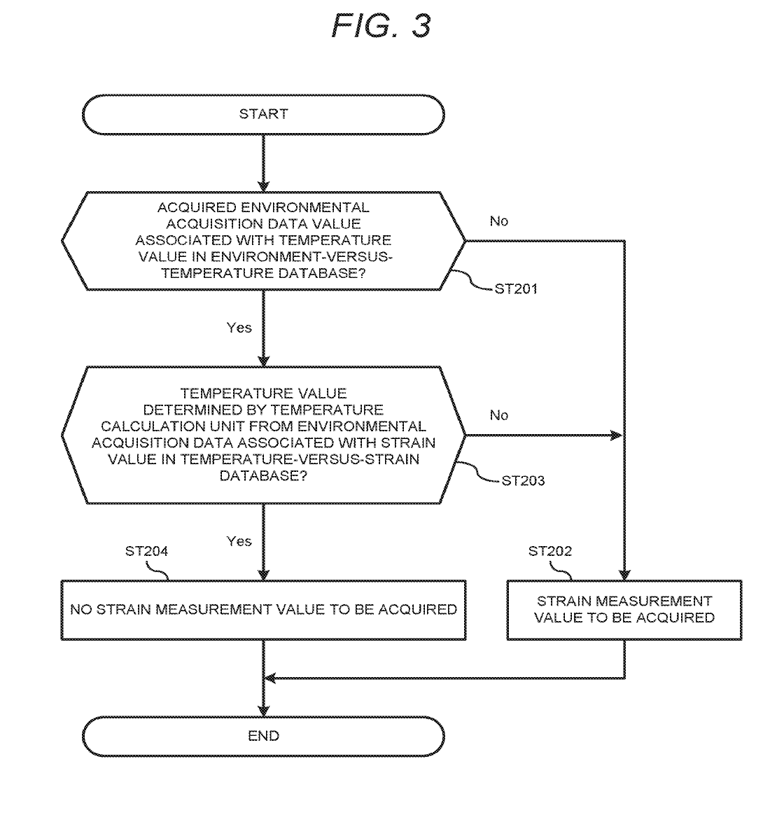

FIG. 3 is a flowchart illustrating an operation of the determination unit 360. This operation is a detailed operation performed to determine whether or not to acquire the strain measurement value (ST103) in FIG. 2. When the strain can be determined from the environmental acquisition data based on the environment-versus-temperature database 320 and the temperature-versus-strain database 330, the determination unit 360 determines that no strain measurement value is to be acquired from the data acquisition unit 310. When the strain cannot be calculated, the determination unit 360 determines that the strain measurement value is to be acquired from the data acquisition unit 310.

The determination unit 360 confirms whether a value of the environmental acquisition data acquired from the data acquisition unit 310 is stored in the environment-versus-temperature database 320, or more specifically, whether the acquired environmental acquisition data value is associated with a temperature value of the structure 100 in the environment-versus-temperature database 320 (ST201). When the values are not associated with each other (NO in ST201), the determination unit 360 determines that the strain measurement value is to be acquired (ST202). When the values are associated with each other (YES in ST201), the determination unit 360 further confirms whether the temperature value associated with environmental acquisition data in the environment-versus-temperature database 320 is stored in the temperature-versus-strain database 330, or more specifically, whether the temperature value of the structure 100 determined by the temperature calculation unit 340 based on the environmental acquisition data and the temperature-versus-strain database 330 is associated with a strain value of the structure 100 in the temperature-versus-strain database 330 (ST203). When the values are not associated with each other (NO in ST203), the determination unit 360 determines that the strain measurement value is to be acquired (ST202). When the values are associated with each other (YES in ST203), the determination unit 360 determines that no strain measurement value is to be acquired (ST204).

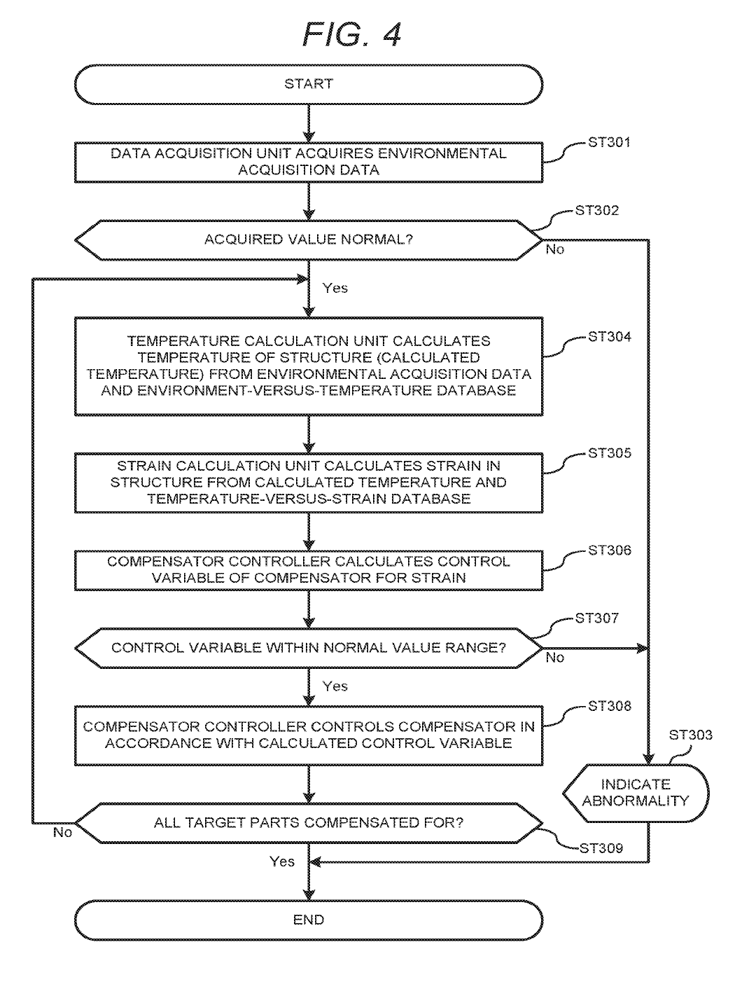

FIG. 4 is a flowchart illustrating an operation of strain calculation based on environmental acquisition data and strain compensation performed by the strain compensation apparatus 200. This operation is a detailed operation performed when no strain measurement is to be performed (ST105) in FIG. 2. The data acquisition unit 310 first acquires the environmental acquisition data measured by the observation device 430 (ST301). The data acquisition unit 310 confirms whether the acquired environmental acquisition data is normal (ST302). When the environmental acquisition data acquired by the data acquisition unit 310 is abnormal (NO in ST302), the strain compensation apparatus 200 indicates the abnormality (ST303) and ends the operation. When the data is normal (YES in ST302), the strain compensation apparatus 200 performs the processing in ST304 and subsequent steps. When the strain compensation apparatus 200 indicates the abnormality in ST303, the operator determines the cause of the abnormality, and updates, for example, the information in the environment-versus-temperature database 320 or the temperature-versus-strain database 330 based on newly measured data.

When the environmental acquisition data is normal (YES in ST302), the temperature calculation unit 340 estimates the temperature of the structure 100 from the environmental acquisition data and the environment-versus-temperature database 320 (ST304). The strain calculation unit 350 then determines the strain in the structure 100 from the temperature calculated by the temperature calculation unit 340 and the temperature-versus-strain database 330 (ST305). The compensator controller 210 then calculates the control variable of the compensator 120 for the strain determined by the strain calculation unit 350 (ST306). The compensator controller 210 confirms whether the calculated control variable is within a normal value range (ST307). When the calculated control variable is outside the normal value range (NO in ST307), the compensator controller 210 notifies the strain compensation apparatus 200 of the abnormality. The strain compensation apparatus 200 indicates the abnormality (ST303) and ends the operation. When the calculated control variable is within the normal value range (YES in ST307), the compensator controller 210 controls the compensator 120 in accordance with the calculated control variable (ST308). The strain compensation apparatus 200 confirms whether all the target parts of the structure 100 have undergone strain compensation (ST309). When all the target parts have undergone strain compensation (YES in ST309), the operation ends. When strain compensation is not yet performed for at least one of the target parts (NO in ST309), the operation is repeated from ST304 to ST308 until the compensation is complete.

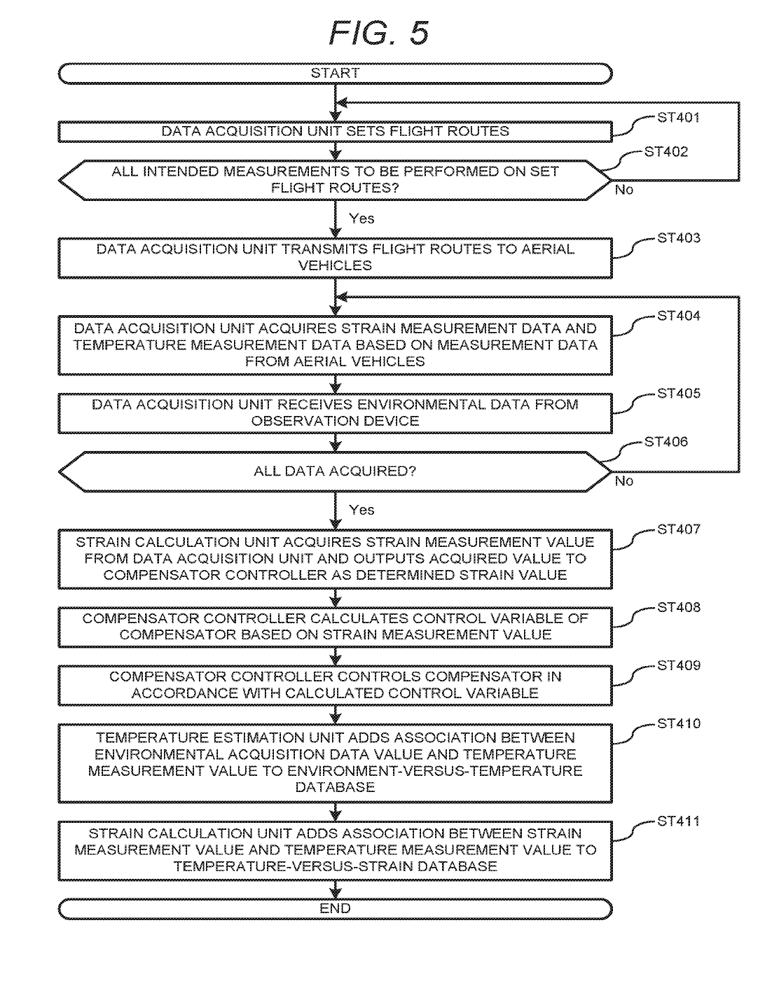

FIG. 5 is a flowchart illustrating an operation of strain measurement for the structure 100 and strain compensation for the structure 100 both performed by the strain compensation apparatus 200. This operation is a detailed operation performed by the strain compensation apparatus 200 when strain measurement is to be performed (ST104) in FIG. 2. In the operation illustrated in FIG. 5 performed by the strain compensation apparatus 200, the data acquisition unit 310 acquires strain measurement data by controlling the photogrammetry device 410, the aerial vehicle 501 carrying the photogrammetry device 410, the thermography device 420, and the aerial vehicle 502 carrying the thermography device 420. The strain measurement data is used as the strain value of the structure 100 determined by the strain calculation apparatus 300. The strain compensation apparatus 200 compensates for the strain in the structure 100 based on the strain determined by the strain calculation apparatus 300, or more specifically, on the strain measurement value acquired by the data acquisition unit 310.

The strain compensation apparatus 200 performs the operation illustrated in FIG. 5 when the environmental acquisition data value is not associated with a temperature value in the environment-versus-temperature information or the temperature value determined from the environmental acquisition data and the environment-versus-temperature information is not associated with a strain value in the temperature-versus-strain information in the operation in FIG. 2. Thus, the strain compensation apparatus 200, which acquires the strain measurement value, also acquires the temperature measurement value of the structure 100 measured when the strain measurement value is measured. The strain compensation apparatus 200 then associates the environmental acquisition data value with the temperature measurement value to add the associated values to the environment-versus-temperature information, and associates the strain measurement value with the temperature measurement value measured when the strain measurement value is measured to add the associated values to the temperature-versus-strain information. More specifically, the strain compensation apparatus 200 associates the environmental acquisition data with the temperature measurement value measured when the environmental acquisition data is acquired and stores the associated values into the environment-versus-temperature database 320, and associates the strain measurement value with the temperature measurement value measured when the strain measurement value is measured and stores the associated values into the temperature-versus-strain database 330.

The data acquisition unit 310 first sets flight routes for the aerial vehicles 501 and 502 based on the shape of the structure 100 (ST401). The flight routes include measurement locations at which the photogrammetry device 410 on the aerial vehicle 501 and the thermography device 420 on the aerial vehicle 502 measure the structure 100. The measurement locations are set based on the shape of the structure 100. The data acquisition unit 310 then confirms whether the photogrammetry device 410 on the aerial vehicle 501 and the thermography device 420 on the aerial vehicle 502 can perform intended measurements on the set flight routes (ST402). More specifically, the data acquisition unit 310 confirms the set flight routes to determine, for example, whether the aerial vehicles 501 and 502 can reach their measurement points without coming in contact with the structure 100, whether there is sufficient time for the photogrammetry device 410 and the thermography device 420 to perform measurement at the measurement points, and whether the aerial vehicles 501 and 502 can fly the entire flight routes within a predetermined time period and with a predetermined fuel or battery capacity. When the measurement cannot be performed (NO in ST402), the data acquisition unit 310 resets the flight routes (ST401). When the measurement can be performed (YES in ST402), the data acquisition unit 310 transmits the set flight routes to the aerial vehicles 501 and 502 (ST403). After the measurement starts, the data acquisition unit 310 acquires a strain measurement value of the structure 100 determined based on the photographic data captured by the photogrammetry device 410 from the aerial vehicle 501, and acquires temperature measurement data measured by the thermography device 420 from the aerial vehicle 502 (ST404). The data acquisition unit 310 also acquires environmental acquisition data from the observation device 430 (ST405). The data acquisition unit 310 confirms whether all the target data is acquired from the aerial vehicles 501 and 502 (ST406). If all the data is not yet acquired (NO in ST406), the processing in ST404 and ST405 is repeated. When all the data is acquired (YES in ST406), the processing advances to ST407 and subsequent steps.

After the data acquisition unit 310 acquires the data, the strain calculation unit 350 outputs the strain measurement data acquired from the data acquisition unit 310 to the compensator controller 210 as the strain in the structure 100 determined by the strain calculation unit 350 (ST407). The compensator controller 210 calculates the control variable of the compensator 120 based on the strain determined by the strain calculation unit 350 (ST408), and controls the compensator 120 in accordance with the calculated control variable (ST409).

The temperature calculation unit 340 associates the environmental acquisition data value with the temperature measurement value of the structure 100 measured when the environmental acquisition data is acquired, and adds the associated values to the environment-versus-temperature information. In other words, the temperature calculation unit 340 stores the environmental acquisition data value and the temperature measurement value of the structure 100 measured when the environmental acquisition data is acquired into the environment-versus-temperature database 320 in a manner associated with each other (ST410). More specifically, the temperature calculation unit 340 transmits the environmental acquisition data value and the temperature measurement value of the structure 100 measured when the environmental acquisition data is acquired to the storage 370 storing the environment-versus-temperature database 320. Upon receiving the environmental acquisition data value and the temperature measurement value of the structure 100 from the temperature calculation unit 340, the storage 370 stores the received environmental acquisition data value and temperature measurement value of the structure 100 in a manner associated with each other as information into the environment-versus-temperature database 320.

The strain calculation unit 350 associates the strain measurement value of the structure 100 with the temperature measurement value of the structure 100 measured when the strain measurement value is measured, and stores the values as the temperature-versus-strain information. In other words, the strain calculation unit 350 stores the strain measurement value of the structure 100 and the temperature measurement value measured when the strain measurement value is measured into the temperature-versus-strain database 330 in a manner associated with each other (ST411). More specifically, the strain calculation unit 350 transmits the strain measurement value of the structure 100 and the temperature measurement value measured when the strain measurement value is measured to the storage 370 storing the temperature-versus-strain database 330. Upon receiving the strain measurement value and the temperature measurement value from the strain calculation unit 350, the storage 370 stores the received strain measurement value and temperature measurement value in a manner associated with each other as information into the temperature-versus-strain database 330.

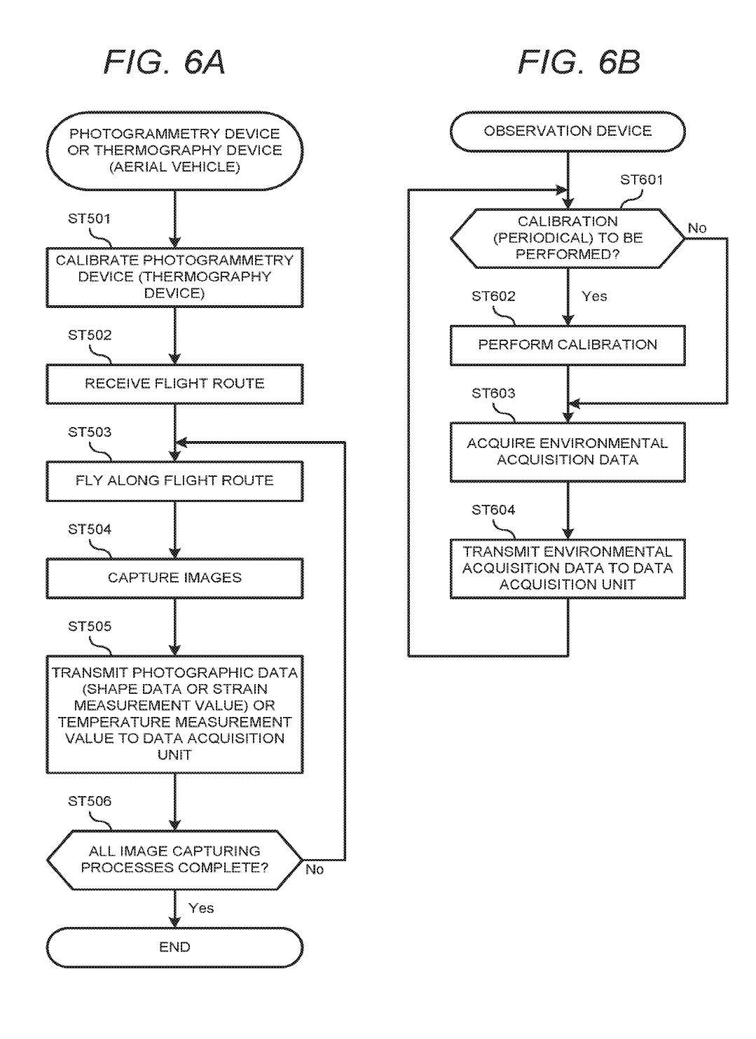

FIGS. 6A and 6B are flowcharts illustrating operations of the sensors that provide measurement data to the strain compensation apparatus 200. FIG. 6A is a flowchart illustrating an operation of the aerial vehicle 501 or 502. Before starting the measurement, the aerial vehicle 501 or 502 calibrates the measurement device, such as the photogrammetry device 410 or the thermography device 420 to carry (ST501), and receives the flight route from the data acquisition unit 310 (ST502). Upon receiving the flight route, the aerial vehicle 501 or 502 flies along the flight route (ST503), allows the photogrammetry device 410 or the thermography device 420 to perform measurement at locations predetermined on the flight route (ST504), and transmits photographic data (or strain measurement data) or temperature measurement data to the data acquisition unit 310 (ST505). The aerial vehicle 501 or 502 confirms whether all the image capturing processes are complete (ST506). When at least one of the image capturing processes is incomplete (NO in ST506), the aerial vehicle 501 or 502 repeats the processing in ST503 to ST505. When all the image capturing processes are complete (YES in ST506), the aerial vehicle 501 or 502 ends the image capturing, and returns.

FIG. 6B is a flowchart illustrating an operation of the observation device 430. The observation device 430 determines whether to perform calibration (ST601). Calibration is performed at, for example, predetermined regular intervals. When a determination is made to perform calibration (YES in ST601), the observation device 430 performs calibration (ST602), and subsequently acquires environmental acquisition data (ST603). When a determination is made not to perform calibration (NO in ST601), the observation device 430 simply acquires the environmental data (ST603). The observation device 430 transmits the acquired environmental acquisition data to the data acquisition unit 310 (ST604), and repeats the processing from ST601.

As described above, the strain calculation apparatus 300 according to Embodiment 1 of the present disclosure may calculate the temperature of the structure 100 from the environmental acquisition data, and determine the strain in the structure 100 from the calculated temperature and the temperature-versus-strain information without measuring the strain in the structure 100. The strain compensation apparatus 200 according to Embodiment 1 of the present disclosure may use the strain determined by the strain calculation apparatus 300 to compensate for the strain in the structure 100 without measuring the strain. This reduces the operational burden of strain measurement. The strain calculation apparatus 300 according to Embodiment 1 of the present disclosure determines whether to measure strain based on the environmental acquisition data. This reduces the frequency of strain measurement performed in determining the strain in the structure 100. The strain compensation apparatus 200 according to Embodiment 1 of the present disclosure uses the strain determined by the strain calculation apparatus 300 as described above to compensate for the strain in the structure 100. This reduces the frequency of strain measurement for the structure to compensate for the strain in the structure.

In the above structure, the determination unit 360 determines both whether the environmental acquisition data value is associated with a temperature value in the environment-versus-temperature information and whether the temperature value determined from the environmental acquisition data and the environment-versus-temperature information is associated with a strain value in the temperature-versus-strain information. However, two determination units may be used. One determination unit may determine whether the environmental acquisition data value is associated with a temperature value in the environment-versus-temperature information, and the other determination unit may then determine the temperature value determined from the environmental acquisition data and the environment-versus-temperature information is associated with a strain value in the temperature-versus-strain information. In some embodiments, the temperature calculation unit 340 may determine whether the environmental acquisition data value is associated with a temperature value in the environment-versus-temperature information, and the strain calculation unit 350 may determine whether the temperature value determined from the environmental acquisition data and the environment-versus-temperature information is associated with a strain value in the temperature-versus-strain information.

As described above, the environmental data and the environmental acquisition data preferably includes all of solar radiation data, heat exchange environmental data, outside air temperature data, and rainwater data. However, the environmental data and the environmental acquisition data need not include all of the above data items. For example, the temperature of the structure 100 installed underground or inside a shelter is unaffected by solar radiation and wind. In this case, the temperature of the structure 100 can be estimated simply from the outside air temperature data. Thus, the temperature calculation unit 340 can determine the temperature of the structure 100 from the environmental acquisition data simply including the outside air temperature data value and the environment-versus-temperature database 320 that stores the environmental data simply including the outside air temperature data value in a manner associated with the temperature value of the structure 100.

The temperature of the structure 100 changes over a long time through radiation of heat to the outside air or reception of heat radiated from the outside air. For the structure 100 operating for a short time and housed in a shelter while not operating, for example, the temperature of the structure 100 can be estimated simply from the solar radiation data and the heat exchange environmental data. In this case, the temperature calculation unit 340 can determine the temperature of the structure 100 from environmental acquisition data that simply includes the solar radiation data value and the heat exchange environmental data value, and the environment-versus-temperature database 320 that stores environmental data simply including the solar radiation data value and the heat exchange environmental data value in a manner associated with the temperature value of the structure 100.

For the structure 100 operating for a short time, housed in a shelter while not operating, and further using a windbreak or another protection during operation, the temperature of the structure 100 can be estimated simply from the solar radiation data. In this case, the temperature calculation unit 340 can determine the temperature of the structure 100 from environmental acquisition data simply including the solar radiation data value and the environment-versus-temperature database 320 that stores the environmental data simply including the solar radiation data value in a manner associated with the temperature value of the structure 100.

The temperature of the structure 100 used in the rain can be estimated simply from a rainwater data value. In this case, the temperature calculation unit 340 can determine the temperature of the structure 100 from environmental acquisition data simply including the rainwater data value and the environment-versus-temperature database 320 that stores the environmental data including the rainwater data value in a manner associated with the temperature value of the structure 100.

The environment-versus-temperature information and the temperature-versus-strain information may have validity periods for their associations reflecting factors including seasonal changes in environmental conditions and aging of the structure 100. The associations between sets of information may then be invalidated after the predetermined periods, and strain measurement values and temperature measurement values may then be newly acquired.

Although the strain compensation apparatus 200 and the strain calculation apparatus 300 according to Embodiment 1 of the present disclosure use the photogrammetry device 410 and the thermography device 420 carried by aerial vehicles, these apparatuses may use measurement devices that are not carried by aerial vehicles to similarly reduce the frequency of strain measurement for the structure with any measurement device.

### Embodiment 2

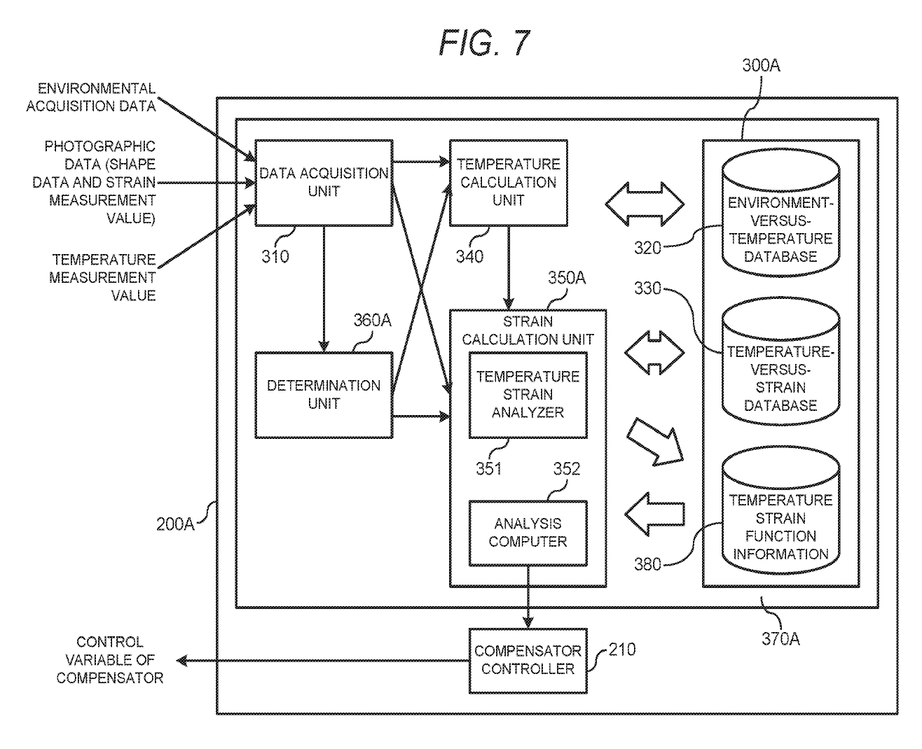

Embodiment 2 of the present disclosure is described next with reference to FIGS. 7 to 9. FIG. 7 is a schematic diagram of a strain compensation apparatus 200A according to Embodiment 2 of the present disclosure. The structure 100 as a target to undergo strain compensation is the same as in FIG. 1, and is not illustrated in FIG. 7. As illustrated in FIG. 7, the strain compensation apparatus 200A includes a strain calculation apparatus 300A and the compensator controller 210. Similarly to the strain calculation apparatus 300 according to Embodiment 1, the strain calculation apparatus 300A calculates strain in the structure 100 from environmental acquisition data using the environment-versus-temperature information, which associates the environmental data at the installation location of the structure 100 with the temperature of the structure 100 acquired when the environmental data is acquired, and the temperature-versus-strain information, which associates the temperature of the structure 100 with the strain in the structure 100 at the temperature.

The strain calculation apparatus 300A additionally uses temperature strain function information 380, unlike the strain calculation apparatus 300. The temperature strain function information 380 associates the temperature of the structure 100 with the strain in the structure 100 at the temperature using a predetermined function. More specifically, the function is a linear equation determined by a reference strain value, which is the strain in the structure 100 at a reference temperature, and the rate of change of strain in the structure 100 with respect to temperature. The temperature strain function information 380 includes the reference strain value and the rate of strain change with respect to temperature, which determine the function associating the temperature of the structure 100 with the strain in the structure 100 at the temperature. The data representing the temperature strain function information 380 is stored in the storage 370. In FIG. 7, the data representing the temperature strain function information 380 is stored in the same storage as for the data in the environment-versus-temperature database 320 and the data in the temperature-versus-strain database 330. However, the data representing the temperature strain function information 380 may be stored in a storage different from the storage storing the data in the environment-versus-temperature database 320 or the storage storing the data in the temperature-versus-strain database 330. The storage 370 storing the data representing the temperature strain function information 380 may be included in the strain calculation apparatus 300A or may be on a network or the like external to the strain calculation apparatus 300A and the strain compensation apparatus 200A.

The temperature strain function information 380 associates the temperature of the structure 100 with the strain in the structure 100 at the temperature using a function determined by the strain in the structure 100 at a reference temperature and the rate of strain change in the structure 100 with respect to temperature. In Embodiment 2, the temperature strain function information 380 serves as the temperature-versus-strain information for calculating strain from the temperature of the structure 100.

Unlike the strain calculation apparatus 300, the strain calculation apparatus 300A includes a strain calculation unit 350A in place of the strain calculation unit 350. The strain calculation unit 350A calculates strain in the structure 100 from the temperature of the structure 100 and the temperature strain function information 380. The strain calculation apparatus 300A also includes, unlike the strain calculation apparatus 300, a determination unit 360A in place of the determination unit 360. The determination unit 360A determines whether strain measurement data is to be acquired based on the data in the environment-versus-temperature database 320.

The coefficients of thermal expansion for solids are constant at any temperature. The structure 100, which is formed from a solid having a constant coefficient of thermal expansion, has the constant rate of strain change with respect to temperature in each part. Thus, a strain r in the structure 100 at a temperature t can be expressed with a linear function of formula (1), where t₀ is a reference temperature, r₀ is the strain in the structure 100 at to (hereafter, a reference strain), and a is the rate of strain change with respect to temperature. Using formula (1), when the values r₀ and a are known, the strain r in the structure 100 is calculated from the temperature t. The arrows in formula (1) indicate vectors.

Formula 1

\vec{r}=\vec{r₀}+(t−t₀)\vec{α} (1)

The strain calculation unit 350A includes a temperature strain analyzer 351 and an analysis computer 352. The temperature strain analyzer 351 performs linear regression analysis on the temperature and strain values associated in the temperature-versus-strain database 330, and calculates the reference strain (r₀) of the structure 100 and the rate of strain change (α) in the structure 100 with respect to temperature. The temperature strain function information 380 includes the reference strain (r₀) of the structure 100 and the rate of strain change (α) in the structure 100 with respect to temperature calculated by the temperature strain analyzer 351. The temperature strain function information 380 is stored in the storage 370 as data. The analysis computer 352 substitutes the temperature (t) of the structure 100 into formula (1) based on the temperature strain function information 380, and computes the strain in the structure 100.

Similarly to the strain compensation apparatus 200, the strain calculation apparatus 300A calculates the strain in the structure 100 using the environment-versus-temperature information, which associates environmental data with the temperature of the structure 100 acquired when the environmental data is acquired, and the temperature-versus-strain information, which associates the temperature of the structure 100 with the strain in the structure 100 at the temperature. The strain calculation unit 350A included in the strain calculation apparatus 300A calculates the strain in the structure 100 using, in place of the temperature-versus-strain database 330, the reference strain (r₀) of the structure 100 and the rate of strain change (α) in the structure 100 with respect to temperature, which are calculated from the temperature-versus-strain database 330. The strain calculation unit 350A calculates the strain in the structure 100 from the temperature of the structure 100 using formula (1). Thus, the strain calculation unit 350A can calculate the strain in the structure 100 for a temperature value that is not stored in the temperature-versus-strain database 330.

Similarly to the strain compensation apparatus 200, the strain compensation apparatus 200A follows the operation illustrated in FIG. 2. However, as described above, the strain calculation unit 350A can calculate the strain in the structure 100 for a temperature that is not stored in the temperature-versus-strain database 330, and thus less strain measurement data is used.

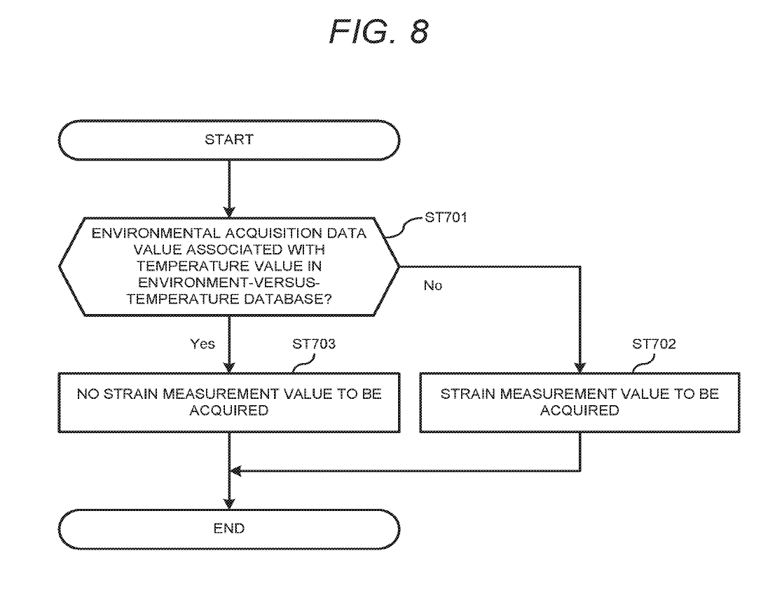

FIG. 8 is a flowchart illustrating an operation of the determination unit 360A included in the strain compensation apparatus 200A. This operation is a detailed operation performed to determine whether or not to acquire the strain data of the structure 100 (ST103) in FIG. 2. The determination unit 360A confirms whether a value of the environmental acquisition data acquired from the data acquisition unit 310 is stored in the environment-versus-temperature database 320, or more specifically, whether the acquired value is associated with a temperature of the structure 100 in the environment-versus-temperature database 320 (ST701). When the values are not associated with each other (NO in ST701), the determination unit 360A determines that strain measurement is to be performed (ST702).

When the values are associated with each other (YES in ST701), the determination unit 360A determines that no strain measurement is to be performed (ST703). In the operation illustrated in FIG. 8 the estimated temperature value of the structure 100 calculated by the temperature calculation unit 340 is without exception assumed to be a temperature value that is associated in the temperature strain function information 380. Thus, the determination unit 360A does not determine whether the estimated temperature value of the structure 100 is associated with a temperature value in the temperature strain function information 380, and completely eliminates strain measurement when the determination result is YES in ST701. However, when, for example, the estimated temperature value of the structure 100 can fail to serve as the temperature value associated in the temperature strain function information 380 due to certain circumstances, the operation may also include, as in the operation illustrated in FIG. 3, determining whether the estimated temperature value of the structure 100 serves as the temperature value associated in the temperature strain function information 380.

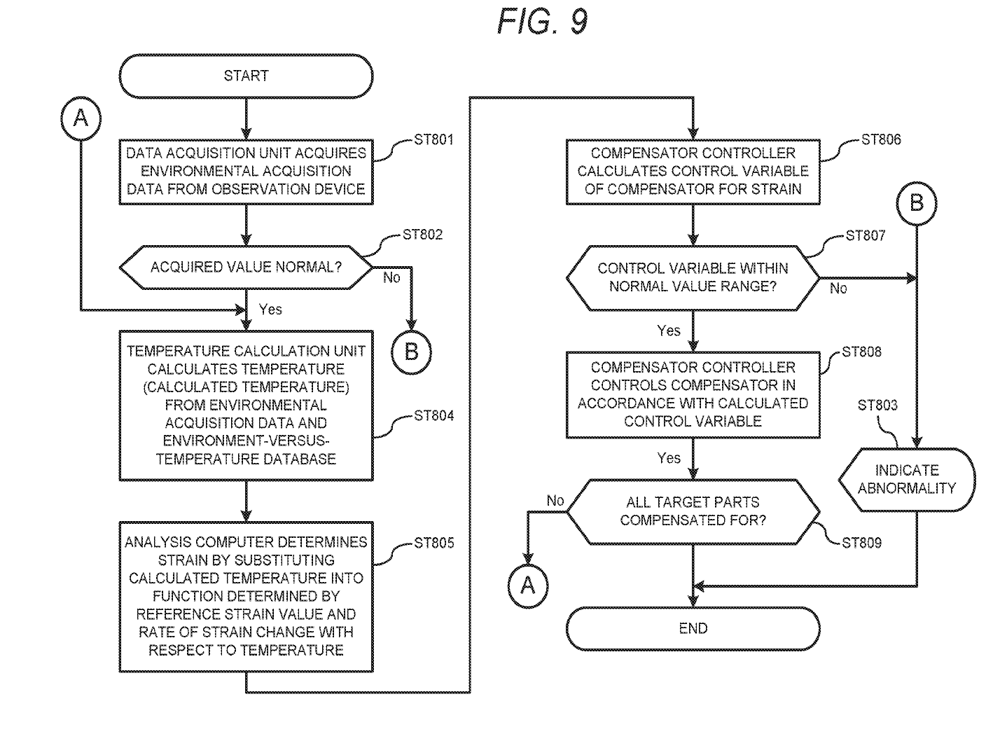

FIG. 9 is a flowchart illustrating an operation of strain calculation based on the environmental acquisition data and strain compensation performed by the strain compensation apparatus 200A. This operation is a detailed operation performed when no strain measurement value is to be acquired (ST105) in FIG. 2. Before the operation illustrated in FIG. 9 starts, the temperature strain analyzer 351 calculates the reference strain (r₀) of the structure 100 and the rate of strain change (α) in the structure 100 with respect to temperature based on the temperature-versus-strain database 330, and stores the calculated values into the storage 370 as data representing the temperature strain function information 380. This operation of the temperature strain analyzer 351 associates the temperature of the structure 100 with the strain in the structure 100 at the temperature in the temperature strain function information 380 serving as the temperature-versus-strain information.

As illustrated in FIG. 9, the data acquisition unit 310 first acquires environmental acquisition data acquired by the observation device 430 (ST801). The data acquisition unit 310 confirms whether the acquired environmental acquisition data is normal (ST802). When the environmental acquisition data acquired by the data acquisition unit 310 is abnormal (NO in ST802), the strain compensation apparatus 200A indicates the abnormality (ST803) and ends the operation. When the environmental acquisition data acquired by the data acquisition unit 310 is normal (YES in ST802), the strain compensation apparatus 200A performs the processing in ST804 and subsequent steps.

The temperature calculation unit 340 calculates the temperature of the structure 100 from the environmental acquisition data and the environment-versus-temperature database 320 (ST804). The analysis computer 352 then determines the strain in the structure 100 by substituting the temperature calculated by the temperature calculation unit 340 into the function determined by the reference strain (r₀) and the rate of strain change (α) with respect to temperature stored in the temperature strain function information 380 (ST805).

After the strain calculation unit 350A determines the strain, the compensator controller 210 calculates the control variable of the compensator for the strain determined by the strain calculation unit 350A (ST806). The compensator controller 210 confirms whether the calculated control variable is within a normal value range (ST807). When the calculated control variable is outside the normal value range (NO in ST807), the strain compensation apparatus 200A indicates the abnormality (ST803) and ends the operation. When the calculated control variable is within the normal value range (YES in ST807), the compensator controller 210 controls the compensator 120 in accordance with the calculated control variable (ST808). The strain compensation apparatus 200A confirms whether all the target parts of the structure 100 have undergone strain compensation (ST809). When all the target parts have undergone strain compensation (YES in ST809), the operation ends. When at least one of the target parts is yet to undergo strain compensation (NO in ST809), the operation is repeated from ST804 to ST808 until the compensation is complete.

When the strain compensation apparatus 200A indicates the abnormality in ST803, the operator determines the cause of the abnormality, and updates, for example, the information in the environment-versus-temperature database 320, the temperature-versus-strain database 330, or the temperature strain function information 380 based on newly measured data.

The operation of the strain compensation apparatus 200A to be performed to measure the strain is the same as the operation in FIG. 5, and thus is not described. The operations of the sensors that provide the measurement data to the strain compensation apparatus 200A are also the same as the operations in FIGS. 6A and 6B, and thus are not described.

In the above embodiment, the reference strain and the rate of strain change with respect to temperature are calculated by the temperature strain analyzer 351 before the operation illustrated in FIG. 9 starts. However, the reference strain and the rate of strain change with respect to temperature may be calculated after the temperature calculation unit 340 estimates the temperature of the structure 100 in ST804 and before the analysis computer 352 computes the strain in ST805.

As described above, the strain compensation apparatus 200A according to Embodiment 2 of the present disclosure includes the temperature strain analyzer 351, which calculates the strain at a reference temperature and the rate of strain change with respect to temperature based on the data in the temperature-versus-strain database 330, and the analysis computer 352, which calculates the strain from the temperature of the structure 100 based on the strain at the reference temperature and the rate of strain change with respect to temperature. Thus, the strain calculation unit 350A can determine the strain in the structure 100 simply with the temperature of the structure 100 without measuring the strain. Thus, the strain compensation apparatus 200A may have fewer situations in which strain measurement of the structure 100 is to be performed by the photogrammetry device 410 than the strain compensation apparatus 200 according to Embodiment 1, and compensates for the strain in the structure 100 efficiently.

### Embodiment 3

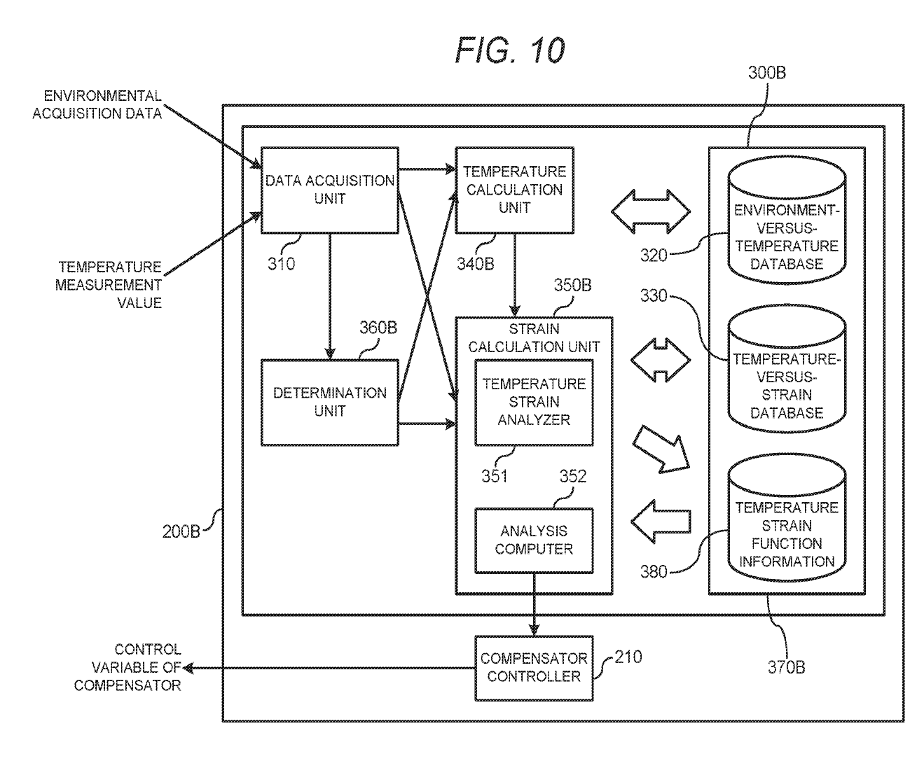

Embodiment 3 of the present disclosure is described next with reference to FIGS. 10 to 13. FIG. 10 is a schematic diagram of a strain compensation apparatus 200B according to Embodiment 3 of the present disclosure. As illustrated in FIG. 10, the strain compensation apparatus 200B includes a strain calculation apparatus 300B and the compensator controller 210. The structure 100 as a target to undergo strain compensation is the same as in FIG. 1, and is not illustrated in FIG. 10. The strain calculation apparatus 300B differs from the strain calculation apparatus 300A in including a determination unit 360B in place of the determination unit 360A, a temperature calculation unit 340B in place of the temperature calculation unit 340, and a strain calculation unit 350B in place of the strain calculation unit 350A. The determination unit 360B determines whether the temperature of the structure 100 is to be measured based on the environmental acquisition data. The temperature calculation unit 340B outputs either the temperature calculated from the environmental acquisition data and the environment-versus-temperature data or a temperature measurement value to the strain calculation unit 350B depending on the determination result from the determination unit 360B. The strain calculation unit 350B determines the strain in the structure 100 based on the temperature estimated by the temperature calculation unit 340 or the temperature data acquired from the data acquisition unit 310.

When the strain in the structure 100 cannot be determined from environmental data, the strain compensation apparatus 200 according to Embodiment 1 and the strain compensation apparatus 200A according to Embodiment 2 acquire strain measurement data based on a result of image capturing by the photogrammetry device 410. However, measuring the shape of the structure 100 and the strain in the structure 100 based on the image capturing result of the photogrammetry device 410 uses images of one point in the structure 100 captured from multiple locations. In contrast, the temperature measurement by the thermography device 420 uses a single image captured for each point in the structure 100 to determine the temperature of the structure 100. Thus, the temperature measurement with the thermography device 420 may be easier than the shape or strain measurement with the photogrammetry device 410 for acquiring data used to determine the strain in the structure 100. Thus, the measurement for determining the strain in the structure 100 may be easier simply with the temperature measurement data acquired by the thermography device 420 than with results acquired by the photogrammetry device 410, thus reducing the operational burden. The strain compensation apparatus 200B determines the strain in the structure 100 by acquiring the environmental data or the temperature data from the data acquisition unit 310, and compensates for the determined strain.

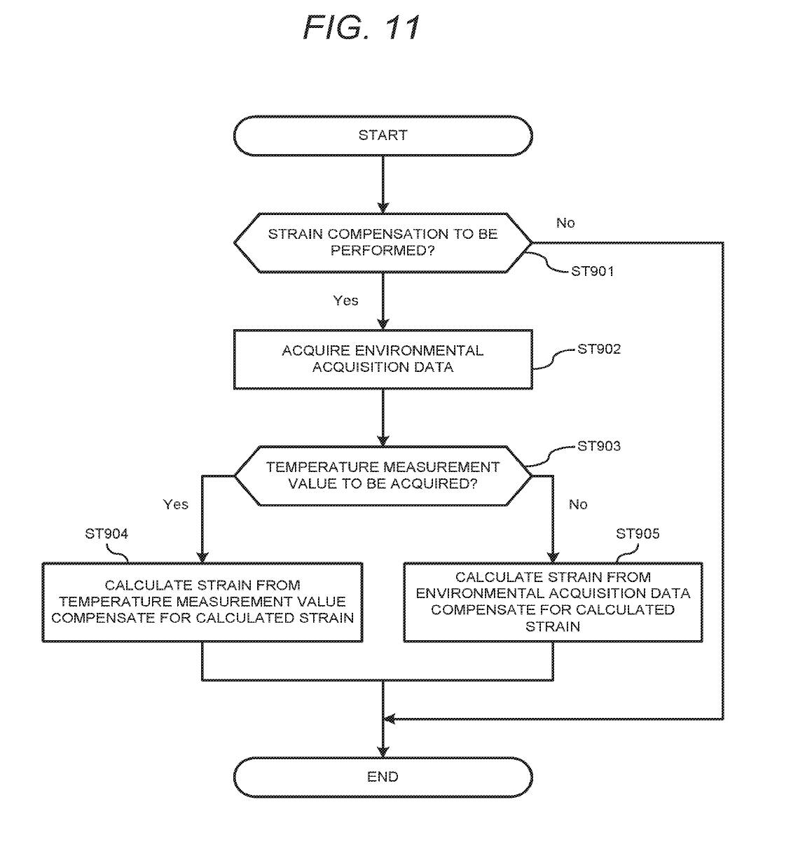

FIG. 11 is a flowchart illustrating an operation of the strain compensation apparatus 200B. The strain compensation apparatus 200B determines whether to perform strain compensation in response to changes in environmental data and operational requirements, and the like (ST901). When a determination is made that no strain compensation is to be performed (NO in ST901), the operation ends without compensation. When a determination is made that strain compensation is to be performed (YES in ST901), the data acquisition unit 310 acquires environmental data from the observation device 430 (ST902).

The determination unit 360B then determines whether the temperature of the structure 100 is to be measured based on the acquired environmental data (ST903). When a determination is made that the temperature of the structure 100 is to be measured (YES in ST903), the temperature calculation unit 340B acquires the temperature measurement data measured by the thermography device 420 from the data acquisition unit 310, and outputs the data to the strain calculation unit 350B as the temperature calculated by the temperature calculation unit 340B. The strain calculation unit 350B determines the strain in the structure 100 by substituting the calculated temperature output from the temperature calculation unit 340B into the function determined by the reference strain (r₀) and the rate of strain change (α) in the structure 100 with respect to temperature stored in the temperature strain function information 380. The compensator controller 210 determines the control variable of the compensator 120 based on the strain determined by the strain calculation unit 350B, and controls the compensator 120 in accordance with the determined control variable to compensate for the strain in the structure 100 (ST904). When the temperature of the structure 100 is determined not to be measured (NO in ST903), the strain calculation unit 350B determines the strain in the structure 100 from the temperature estimated by the temperature calculation unit 340 based on the environmental acquisition data and the environment-versus-temperature database 320, the reference strain (r₀) of the structure 100 at a reference temperature, and the rate of strain change (α) in the structure 100 with respect to temperature. The compensator controller 210 determines the control variable of the compensator 120 based on the strain determined by the strain calculation unit 350B, and controls the compensator 120 in accordance with the determined control variable to compensate for the strain in the structure 100 (ST905).

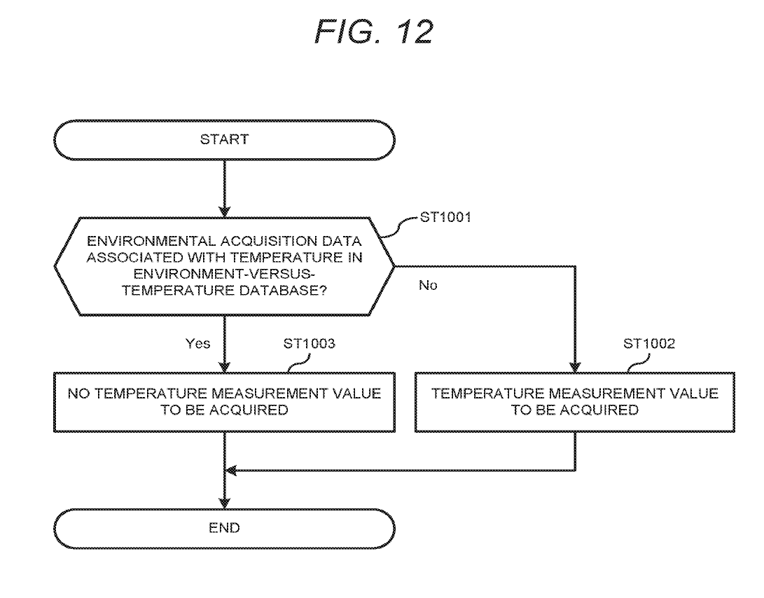

FIG. 12 is a flowchart illustrating an operation of the determination unit 360B included in the strain compensation apparatus 200B. The determination unit 360B confirms whether the value of the environmental acquisition data acquired from the data acquisition unit 310 matches any data stored in the environment-versus-temperature database 320, or more specifically, whether the environmental acquisition data value is associated with a temperature value of the structure 100 in the environment-versus-temperature database 320 (ST1001). When the values are not associated with each other (NO in ST1001), the determination unit 360B determines that temperature data is to be acquired (ST1002). When the value are associated with each other (YES in ST1001), the determination unit 360B determines that no temperature data is to be acquired (ST1003).

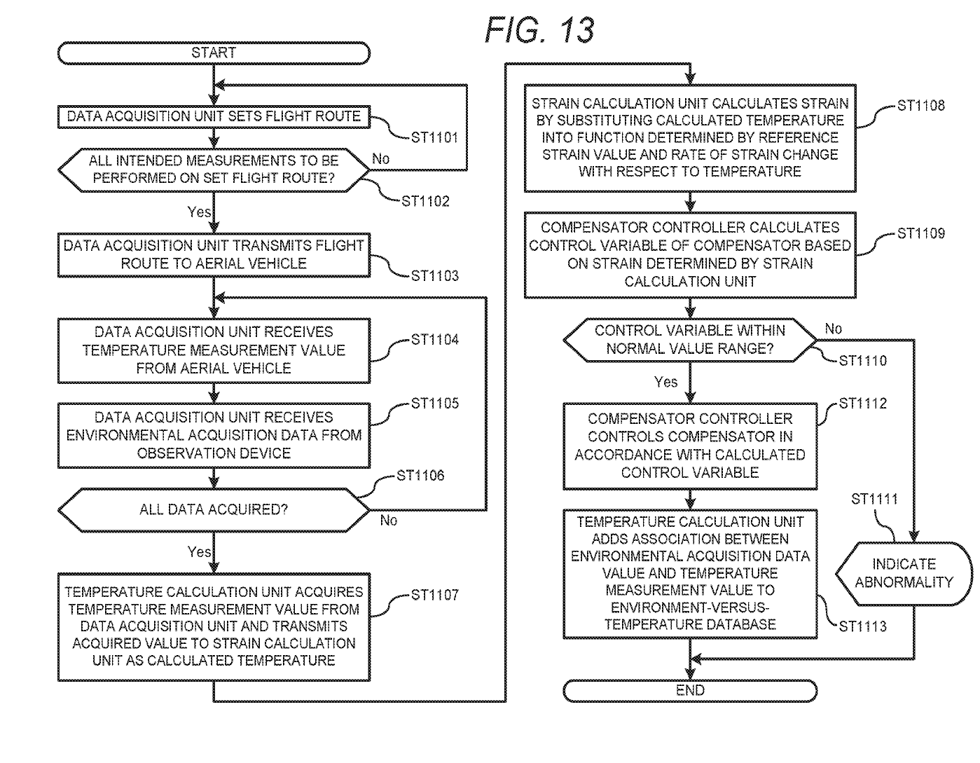

FIG. 13 is a flowchart illustrating an operation of strain calculation based on a temperature measurement value and temperature-versus-strain data and strain compensation performed by the strain compensation apparatus 200B. This operation is a detailed operation performed by the strain compensation apparatus 200B when the temperature data of the structure 100 is to be measured (ST904) in FIG. 11. The data acquisition unit 310 acquires temperature data by controlling the thermography device 420 and the aerial vehicle 502 carrying the thermography device 420. The strain compensation apparatus 200B compensates for the strain in the structure 100 based on the temperature data acquired by the data acquisition unit 310, and stores the data as appropriate.

The data acquisition unit 310 first sets a flight route for the aerial vehicle 502 (ST1101), and confirms whether the thermography device 420 can perform intended measurements on the set flight route (ST1102). When the measurement cannot be performed (NO in ST1102), the data acquisition unit 310 resets the flight route (ST1101). When the measurement can be performed (YES in ST1102), the data acquisition unit 310 transmits the set flight route to the aerial vehicle 502 (ST1103). After the measurement starts, the data acquisition unit 310 acquires the temperature measurement data measured by the thermography device 420 from the aerial vehicle 502 (ST1104). The data acquisition unit 310 also acquires environmental acquisition data measured when the temperature measurement data is measured from the observation device 430 (ST1105). The data acquisition unit 310 confirms whether all the target data is acquired from the aerial vehicle 502 (ST1106). If all of the target data is not yet acquired (NO in ST1106), the processing in ST1104 and ST1105 is repeated. When all the target data is acquired (YES in ST1106), the acquired data is output to the temperature calculation unit 340B.

After the data acquisition unit 310 acquires all the target data, the temperature calculation unit 340B acquires a temperature measurement value from the data acquisition unit 310 and outputs the acquired temperature measurement value to the strain calculation unit 350B as the temperature calculated by the temperature calculation unit 340B (ST1107). The strain calculation unit 350B substitutes the calculated temperature output from the temperature calculation unit 340B into the function determined by the reference strain value and the rate of strain change with respect to temperature in the temperature strain function information 380, and determines the strain in the structure 100 to output the strain to the compensator controller 210 (ST1108).

The compensator controller 210 calculates the control variable of the compensator 120 based on the strain determined by the strain calculation unit 350B (ST1109) The compensator controller 210 confirms whether the calculated control variable is within a normal value range (ST1110). When the calculated control variable is outside the normal value range (NO in ST1110), the compensator controller 210 notifies the strain compensation apparatus 200B of the abnormality. The strain compensation apparatus 200B indicates the abnormality (ST1111) and ends the operation. When the calculated control variable is within the normal value range (YES in ST1110), the compensator controller 210 controls the compensator 120 in accordance with the calculated control variable (ST1112). When the strain compensation apparatus 200B indicates the abnormality in ST1111, the operator determines the cause of the abnormality, and updates, for example, the information in the environment-versus-temperature database 320, the temperature-versus-strain database 330, or the temperature strain function information 380 based on newly measured data.

The temperature calculation unit 340B associates the environmental acquisition data value with the temperature measurement value of the structure 100 measured when the environmental acquisition data is acquired, and adds the associated values to the environment-versus-temperature information. In other words, the temperature calculation unit 340B stores the environmental acquisition data value and the temperature measurement value of the structure 100 measured when the environmental acquisition data is acquired into the environment-versus-temperature database 320 in a manner associated with each other (ST1113). More specifically, the temperature calculation unit 340B transmits the environmental acquisition data value and the temperature measurement value of the structure 100 measured when the environmental acquisition data is acquired to a storage 370B storing the environment-versus-temperature database 320. Upon receiving the environmental acquisition data value and the temperature measurement value of the structure 100 from the temperature calculation unit 340, the storage 370B stores the received environmental acquisition data value and temperature measurement value of the structure 100 in a manner associated with each other as information into the environment-versus-temperature database 320.

As described above, the strain compensation apparatus 200B according to Embodiment 3 determines the strain in the structure 100 using environmental data and temperature data, which are easier to acquire than strain data, and compensates for the strain. This reduces the operational burden of data measurement.

### Embodiment 4

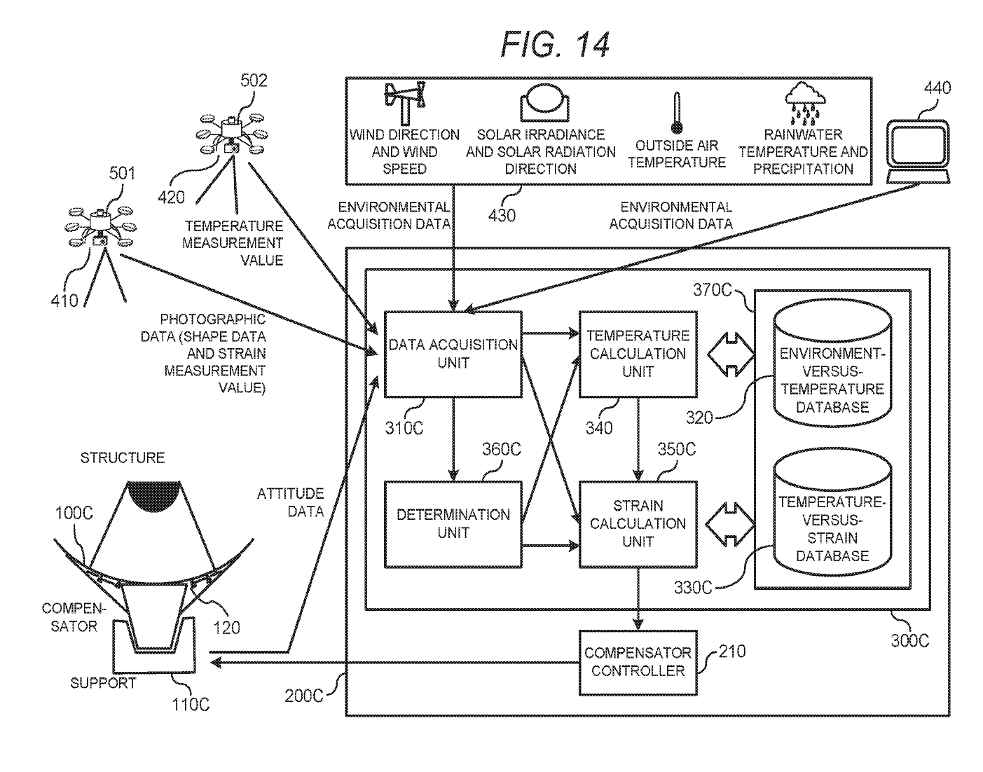

Embodiment 4 of the present disclosure is described next with reference to FIG. 14. FIG. 14 is a schematic diagram of a strain compensation apparatus 200C according to Embodiment 4 of the present disclosure. Large structures can have deflection due to their weight, in addition to thermal expansion. For a structure 100C with a body movably supported on a support 110C to vary the attitude, the strain in the structure can change depending on the attitude of the structure body. Thus, the strain compensation apparatus 200C compensates for the strain in the structure 100C additionally using attitude data for the structure 100C.

The strain compensation apparatus 200C calculates strain in the structure 100C using the environment-versus-temperature information, which associates environmental data with the temperature of the structure 100C acquired when the environmental data is acquired, and the temperature-versus-strain information, which associates the temperature and the attitude of the structure 100C with the strain in the structure 100 at the temperature and in the attitude. The environment-versus-temperature database 320 includes the environment-versus-temperature information in the strain compensation apparatus 200C, and a temperature-versus-strain database 330C includes the temperature-versus-strain information in the strain compensation apparatus 200C.

In the apparatus illustrated in FIG. 14, a data acquisition unit 310C acquires attitude data from the structure 100C, in addition to strain measurement data, temperature measurement data, and environmental acquisition data. The temperature-versus-strain database 330C stores a temperature value of the structure 100C and the strain in the structure 100C at the temperature value in a manner associated with each other for each attitude data value of the structure 100C. A strain calculation unit 350C calculates the strain in the structure 100C from the temperature of the structure 100C calculated by the temperature calculation unit 340 and the temperature-versus-strain database 330C reflecting attitude data values. A determination unit 360C determines, based on environmental data and attitude data, whether strain data or temperature data is to be acquired for the strain calculation apparatus 300C to determine the strain in the structure 100. The components of the strain compensation apparatus 200C other than those described above are the same as the corresponding components of the strain compensation apparatus 200.

The strain compensation apparatus 200C operates in the same manner as the strain compensation apparatus 200 except that the determination unit 360C uses attitude data in addition to environmental data to determine whether strain measurement and temperature measurement are to be performed, and that the strain calculation unit 350C uses the temperature-versus-strain database reflecting attitude data values to determine the strain in the structure 100C. The operation of the strain compensation apparatus 200C thus is not described in detail.

As described above, the strain compensation apparatus 200C according to Embodiment 4 of the present disclosure uses attitude data for the structure 100C. Thus, in addition to having the advantageous effects of the strain compensation apparatus 200 according to Embodiment 1, the strain compensation apparatus 200C determines a strain change in the structure 100C caused by an attitude change and compensates for the strain with no strain measurement.

### Embodiment 5

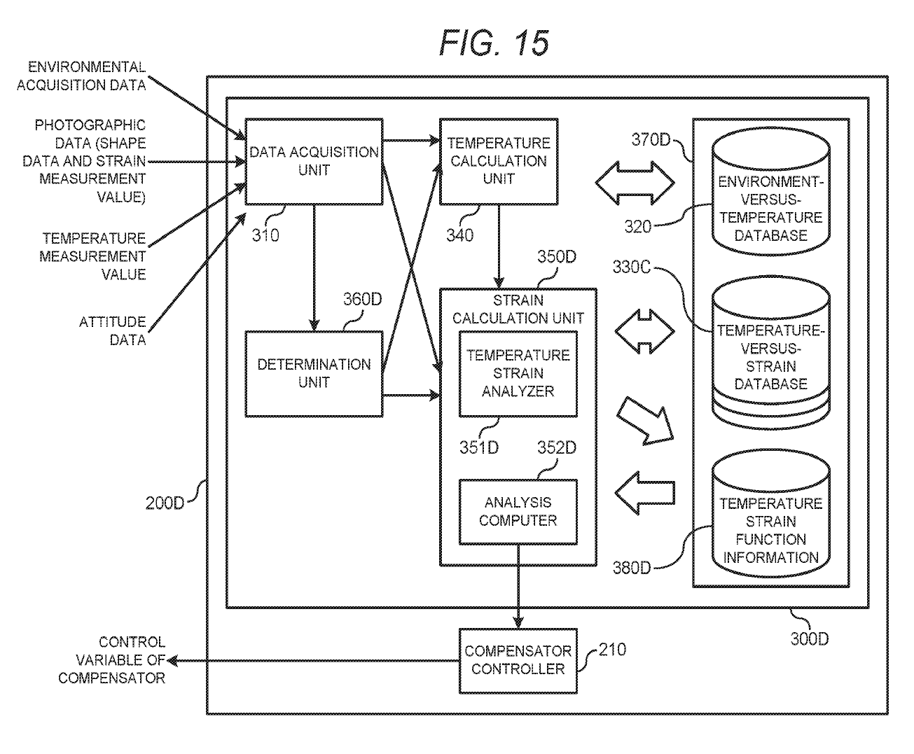

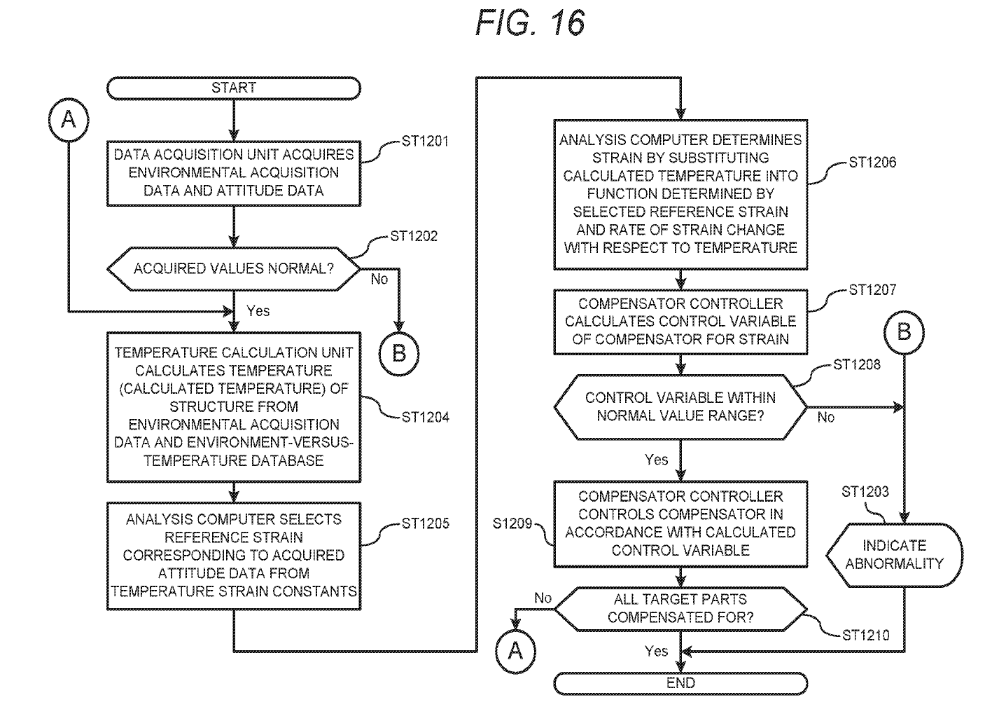

Embodiment 5 of the present disclosure is described next with reference to FIGS. 15 and 16. FIG. 15 is a schematic diagram of a strain compensation apparatus 200D according to Embodiment 5 of the present disclosure. The structure 100C as a target to undergo strain compensation is the same as in FIG. 14, and is not illustrated in FIG. 15. As illustrated in FIG. 15, the strain compensation apparatus 200D includes a strain calculation apparatus 300D and the compensator controller 210. Similarly to the strain calculation apparatus 300C according to Embodiment 4, the strain calculation apparatus 300D calculates strain in the structure 100C from environmental acquisition data using the environment-versus-temperature information, which associates the environmental data at the installation location of the structure 100C with the temperature of the structure 100C acquired when the environmental data is acquired, and the temperature-versus-strain information, which associates the temperature of the structure 100C with the strain in the structure 100C at the temperature.

The strain calculation apparatus 300D additionally uses temperature strain function information 380D, unlike the strain calculation apparatus 300C. The temperature strain function information 380D associates the temperature of the structure 100C with the strain in the structure 100C at the temperature using a predetermined function. More specifically, the function is a linear equation determined by a reference strain value, which is the strain in the structure 100C at a reference temperature, and the rate of change of strain in the structure 100C with respect to temperature. The temperature strain function information 380D includes the reference strain value and the rate of strain change with respect to temperature, which determine the function associating the temperature of the structure 100C with the strain in the structure 100C at the temperature. The reference strain value is determined for each attitude data value of the structure 100C. The data representing the temperature strain function information 380D is stored in a storage 370D. In FIG. 15, the data representing the temperature strain function information 380 is stored in the same storage as for the data in the environment-versus-temperature database 320 and the data in the temperature-versus-strain database 330C. However, the data representing the temperature strain function information 380 may be stored in a storage different from the storage storing the data in the environment-versus-temperature database 320 or the storage storing the data in the temperature-versus-strain database 330C. The storage 370D storing the data representing the temperature strain function information 380D may be included in the strain calculation apparatus 300D or may be on a network or the like external to the strain calculation apparatus 300D and the strain compensation apparatus 200D.

The temperature strain function information 380D associates, for each attitude data value of the structure 100C, the temperature of the structure 100C with the strain in the structure 100C at the temperature using the strain in the structure 100C at a reference temperature and the rate of strain change in the structure 100C with respect to temperature. In Embodiment 5, the temperature strain function information 380D serves as temperature strain data for calculating strain from the temperature of the structure 100C. Unlike the strain calculation apparatus 300C, the strain calculation apparatus 300D includes a strain calculation unit 350D in place of the strain calculation unit 350C. The strain calculation unit 350D determines strain in the structure 100C from the attitude data for the structure 100C, the temperature of the structure 100C, and the temperature strain function information 380D. The strain calculation apparatus 300D also includes, unlike the strain calculation apparatus 300C, a determination unit 360D in place of the determination unit 360C. The determination unit 360D determines whether strain measurement data is to be acquired based on the environment-versus-temperature database 320.

The structure 100C can deform due to gravity and thermal expansion. The gravity affecting the structure 100C changes depending on the attitude of the structure 100C, but remains unchanged at any temperature. Each part of the structure 100C undergoes thermal expansion depending on temperature, but thermal expansion is unaffected by gravity. Thus, the strain caused by gravity and the strain caused by thermal expansion are independent of each other in the structure 100C. The strain in the structure 100C is the sum of the gravity-caused strain determined by the attitude and the thermal expansion-caused strain determined by the temperature.

As described above, the strain in the structure can be expressed as formula (1). The second term in the right side of formula (1) indicates the effects of thermal expansion due to temperature. The first term in the right side of formula (1) (reference strain) indicates strain at a reference temperature (t₀) having a constant effect by temperature. Thus, the first term in the right side of formula (1) changes depending only on the attitude of the structure. Formula (1) can be expressed as formula (2).

Formula 2

\vec{r}=\vec{r_{G}}(attitude)+(t−t₀) (2)

As described above, the second term in the right side of formula (2) indicates the effect of thermal expansion due to temperature. The first term r_{G} (attitude) in the right side of formula (2) indicates a reference strain for each attitude. As described above, the strain in the structure 100C is the sum of the gravity-caused strain determined by the attitude and the thermal expansion-caused strain determined by the temperature. Thus, r_{G} (attitude) corresponds to the deformation due to self-weight, which is determined by the attitude data value. The strain calculation unit 350D performs, for each set of attitude data, linear regression analysis on each pair of temperature measurement data and strain measurement data for the same attitude data stored in the temperature-versus-strain database 330C, and calculates the reference strain (r_{G} (attitude)) and the rate of strain change (α) with respect to temperature. Based on the calculation result, the strain calculation unit 350D determines the strain in the structure 100C from the attitude data and the temperature measurement data.

As illustrated in FIG. 15, the strain calculation unit 350D includes a temperature strain analyzer 351D and an analysis computer 352D. The temperature strain analyzer 351D calculates, for each attitude data value, the reference strain (r_{G} (attitude)) of the structure 100C and the rate of strain change in the structure 100C with respect to temperature based on the temperature-versus-strain database 330C. The temperature strain analyzer 351D further calculates the average of the rate of strain change calculated for each attitude data value, and uses the calculated average as the rate of strain change (α) in the structure 100C with respect to temperature. The temperature strain function information 380D stores the reference strain (r_{G} (attitude)) and the rate of strain change (α) calculated by the temperature strain analyzer 351D. The analysis computer 352D determines the strain in the structure 100C from the attitude data and the temperature measurement value based on the reference strain (r_{G} (attitude)) and the rate of strain change (α) determined by the temperature strain analyzer 351D and stored in the temperature strain function information 380D.

The strain calculation unit 350D calculates the strain in the structure 100 from the attitude data and temperature measurement value of the structure 100C using formula (2). Thus, the strain calculation unit 350D can calculate the strain in the structure 100C for a temperature that is not stored in the temperature-versus-strain database 330C. Unlike environmental data, the attitude of the structure 100C can be set freely. Thus, accumulating attitude data covering an intended range into the temperature strain function information 380D enables strain determination for all attitude data. The strain calculation unit 350D with the above structure determines the strain in the structure 100C from the temperature and the attitude of the structure 100C.

The operation of the strain compensation apparatus 200D is the same as the operation illustrated in FIG. 2. The operation of the determination unit 360D is also the same as the operation illustrated in FIG. 8, which corresponds to the processing in ST103 illustrated in FIG. 2. The operation for acquiring strain measurement data, which corresponds to the processing in ST104 illustrated in FIG. 2, is also the same as the operation in FIG. 5 except that attitude data is acquired in addition to the environmental data. Thus, the operation of the strain compensation apparatus 200D performed when no strain measurement value is to be acquired is described next with reference to FIG. 16.

FIG. 16 is a flowchart illustrating an operation of strain calculation based on environmental acquisition data and strain compensation performed by the strain compensation apparatus 200D. This operation is a detailed operation performed when no strain measurement is to be performed (ST105) in FIG. 2. Before the operation illustrated in FIG. 16 starts, the temperature strain analyzer 351D calculates, for each attitude data value, the reference strain (r_{G} (attitude)) of the structure 100C and the rate of strain change (α) in the structure 100C with respect to temperature based on the temperature-versus-strain database 330, and stores the calculated values into the temperature strain function information 380D. This operation of the temperature strain analyzer 351D associates, for each attitude value of the structure 100C, the temperature of the structure 100C with the strain in the structure 100 at the temperature in the temperature strain function information 380D including the temperature-versus-strain information.

In FIG. 16, the data acquisition unit 310C first acquires environmental acquisition data and attitude data (ST1201). The data acquisition unit 310C confirms whether the acquired environmental acquisition data and attitude data are normal (ST1202). When the environmental acquisition data or the attitude data acquired by the data acquisition unit 310C is abnormal (NO in ST1202), the strain compensation apparatus 200D indicates the abnormality (ST1203), and ends the operation. When the environmental acquisition data and the attitude data acquired by the data acquisition unit 310C are normal (YES in ST1202), the strain compensation apparatus 200D performs the processing in ST1204 and subsequent steps.

The temperature calculation unit 340 estimates the temperature of the structure 100 from the environmental acquisition data and the environment-versus-temperature database 320 (ST1204). The analysis computer 352D selects the reference strain corresponding to the attitude data acquired by the data acquisition unit 310C from the reference strains r_{G} (attitude) stored in the temperature strain function information 380D (ST1205). The analysis computer 352D determines the strain in the structure 100C by substituting the temperature (t) calculated by the temperature calculation unit 340B into the function determined by the reference strain r_{G} (attitude) selected in ST1205 and the rate of change (α) with respect to temperature stored in the temperature strain function information 380D (ST1206).

After the strain calculation unit 350D determines the strain, the compensator controller 210 calculates the control variable of the compensator for the strain determined by the strain calculation unit 350D (ST1207). The compensator controller 210 confirms whether the calculated control variable is within a normal value range (ST1208). When the calculated control variable is outside the normal value range (NO in ST1208), the compensator controller 210 notifies the strain compensation apparatus 200D of the abnormality. The strain compensation apparatus 200D indicates the abnormality (ST1203) and ends the operation. When the calculated control variable is within the normal value range (YES in ST1208), the strain compensation apparatus 200D controls the compensator 120 in accordance with the control variable calculated by the compensator controller 210 (ST1209). The strain compensation apparatus 200D confirms whether all the target parts of the structure 100C have undergone strain compensation (ST1210). When all the target parts have undergone strain compensation (YES in ST1210), the operation ends. When at least one of the target parts is yet to undergo strain compensation (NO in ST1210), the operation is repeated from ST1204 to ST1209 until the compensation is complete.

The reference strain r_{G} (attitude) and the rate of strain change (α) with respect to temperature may be preliminary calculated by the temperature strain analyzer 351D before the operation illustrated in FIG. 16 starts, or may be calculated after the temperature calculation unit 340 estimates the temperature of the structure 100C in ST1204 and before the analysis computer 352D selects a reference strain r_{G} (attitude) in ST1205.

As described above, the strain compensation apparatus 200D according to Embodiment 5 of the present disclosure includes the temperature strain analyzer 351D, which calculates the reference strain being strain at a reference temperature and the rate of strain change with respect to temperature from the temperature-versus-strain database 330C, and the analysis computer 352D, which calculates the strain from the temperature and the attitude of the structure 100C based on the reference strain and the rate of strain change with respect to temperature. Thus, the strain calculation unit 350D can determine the strain in the structure 100C with a changeable attitude, simply with the temperature of the structure 100C without measuring the strain. Thus, the strain compensation apparatus 200D may have fewer situations in which strain measurement of the structure 100C is to be performed by the photogrammetry device 410 than the strain compensation apparatus 200 according to Embodiment 4, and thus compensates for the strain in the structure 100C efficiently.

The strain compensation apparatus 200D may determine, as illustrated in FIGS. 11 to 13, whether to acquire temperature data with the determination unit 360D, and may calculate the strain in the structure 100C from the temperature measurement data measured by the thermography device 420 or the temperature calculated by the temperature calculation unit 340 depending on the determination from the determination unit 360D. The temperature measurement with the thermography device 420 may be easier than the shape measurement with the photogrammetry device 410 for acquiring data used to determine the strain in the structure 100C. Thus, the measurement for determining the strain in the structure 100 may be easier simply with the temperature measurement data acquired by the thermography device 420 than performed by the photogrammetry device 410, thus further reducing the operational burden.

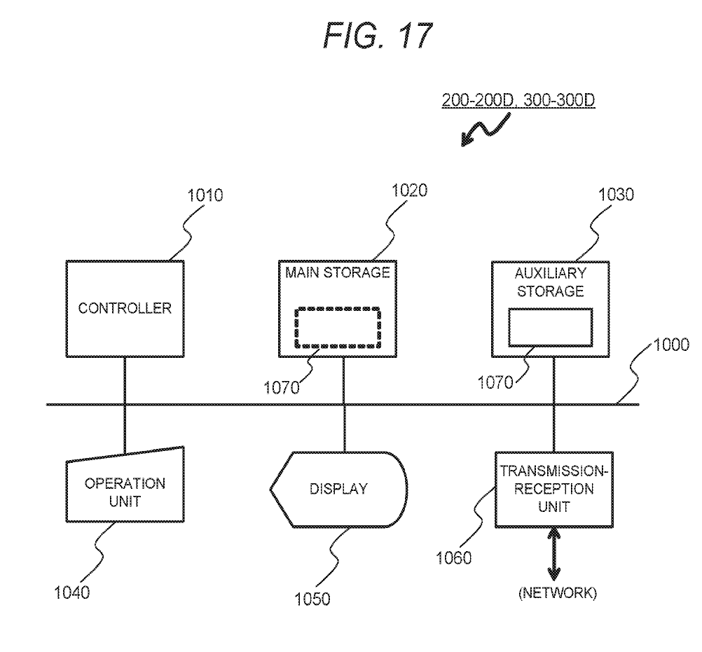

FIG. 17 is a block diagram of the strain calculation apparatus or the strain compensation apparatus according to any embodiment of the present disclosure, illustrating an example hardware configuration of the apparatus. As illustrated in FIG. 17, the strain calculation apparatuses 300 to 300D and the strain compensation apparatuses 200 to 200D each include a controller 1010, a main storage 1020, an auxiliary storage 1030, an operation unit 1040, a display 1050, and a transmission-reception unit 1060. The main storage 1020, the auxiliary storage 1030, the operation unit 1040, the display 1050, and the transmission-reception unit 1060 are all connected to the controller 1010 with an internal bus 1000.

The controller 1010 includes, for example, a central processing unit (CPU). The controller 1010 performs the processing of the data acquisition unit 310 or 310C, the temperature calculation unit 340, the strain calculation unit 350, 350A, 350B, 350C, or 350D, the determination unit 360, 360A, 360B, 360C, or 360D, and the compensator controller 210 in accordance with a control program 1070 stored in the auxiliary storage 1030.

The main storage 1020 includes, for example, a random-access memory (RAM). The control program 1070 stored in the auxiliary storage 1030 is loaded into the main storage 1020 to be executed by the controller 1010. The main storage 1020 is also used as a work area for the controller 1010.

The auxiliary storage 1030 includes a non-volatile memory, such as a flash memory, a hard disk drive, a digital versatile disc random-access memory (DVD-RAM), and a digital versatile disc rewritable (DVD-RW). The auxiliary storage 1030 pre-stores the program for causing the controller 1010 to perform the processing of the strain compensation apparatus 200, 200A, 200B, 200C, or 200D and the strain calculation apparatuses 300, 300A, 300B, 300C, or 300D, and provides the data stored in the program to the controller 1010 in accordance with an instruction from the controller 1010. The auxiliary storage 1030 stores the data provided by the controller 1010 and the data to be used by the controller 1010. The auxiliary storage 1030 serves as the storage 370, which stores the environment-versus-temperature database 320, the temperature-versus-strain database 330, the temperature strain function information 380, and other data.

The operation unit 1040 includes, for example, a keyboard and a pointing device such as a mouse. The operation unit 1040 receives instructions associated with execution of the control program 1070 input from an operator, such as a start, a forced termination, and a restart, which are transferred to the controller 1010 through the internal bus 1000.

The display 1050 includes, for example, a cathode ray tube (CRT) or a liquid crystal display (LCD). The display 1050 displays the execution status of the program, abnormality, and other information.

The transmission-reception unit 1060 includes a network terminator or a wireless communication device connected to a network, and a serial interface or a local area network (LAN) interface connected to such a device. For example, when any of the data sets stored in the storage 370, such as the environment-versus-temperature database 320, the temperature-versus-strain database 330, and the temperature strain function information 380, is provided from a device external to the strain calculation apparatus 300, 300A, 300B, 300C, or 300D and the strain compensation apparatus 200, 200A, 200B, 200C, or 200D, the external data is provided through the transmission-reception unit 1060 to the strain calculation apparatus 300, 300A, 300B, 300C, or 300D and the strain compensation apparatus 200, 200A, 200B, 200C, or 200D.

Each step illustrated in FIGS. 2 to 5, FIGS. 6A and 6B, FIGS. 8 and 9, FIGS. 11 to 13, and FIG. 16 is performed by the control program 1070 using the controller 1010, the main storage 1020, the external storage 1030, the operation unit 1040, the display 1050, and the transmission-reception unit 1060 as resources.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No 2017-013438 filed on Jan. 27, 2017, the entire disclosure of which is incorporated by reference herein.

### INDUSTRIAL APPLICABILITY

The apparatus according to the embodiments of the present disclosure is suitably used to calculate and compensate for strain in a structure.

### REFERENCE SIGNS LIST

100, 100C Structure
110, 110C Support
120 Compensator
200, 200A, 200B, 200C, 200D Strain compensation apparatus
210 Compensator controller
300, 300A, 300B, 300C, 300D Strain calculation apparatus
310, 310C Data acquisition unit
320 Environment-versus-temperature database
330, 330C Temperature-versus-strain database
340, 340B Temperature calculation unit
350, 350A, 350B, 350C, 350D Strain calculation unit
351, 351D Temperature strain analyzer
352, 352D Analysis computer
360, 360A, 360B, 360C, 360D Determination unit
370, 370B, 370D Storage
380, 380D Temperature strain function information
410 Photogrammetry device
420 Thermography device
430 Observation device
440 Environmental data collector
501, 502 Aerial vehicle
1000 Internal bus
1010 Controller
1020 Main storage
1030 Auxiliary storage
1040 Operation unit
1050 Display
1060 Transmission-reception unit
1070 Control program

1: A strain calculation apparatus for calculating strain in a structure based on environment-versus-temperature information and temperature-versus-strain information, the environment-versus-temperature information associating environmental data being data of an environment affecting a temperature increase or decrease in the structure with a temperature of the structure, the temperature-versus-strain information associating a temperature of the structure with a strain in the structure at the temperature, the strain calculation apparatus comprising:
a temperature calculation unit to calculate a temperature of the structure based on environmental acquisition data representing the environmental data acquired at an installation location of the structure, and the environment-versus-temperature information; and
a strain calculation unit to calculate a strain in the structure based on the temperature calculated by the temperature calculation unit and the temperature-versus-strain information.

2: The strain calculation apparatus according to claim 1, wherein
the environmental data includes at least one of (i) solar radiation data being data of solar radiation affecting a temperature increase in the structure, (ii) heat exchange environmental data including wind condition data and outside air temperature data, the heat exchange environmental data being data of a heat exchange environment affecting a temperature increase or decrease in the structure, (iii) outside air temperature data being data of an outside air temperature affecting a temperature increase or decrease in the structure, or (iv) rainwater data being data of rainwater affecting a temperature increase or decrease in the structure.

3: The strain calculation apparatus according to claim 1, wherein
the strain calculation unit calculates the strain in the structure when a value of the calculated temperature is associated with a strain value of the structure in the temperature-versus-strain information.

4: The strain calculation apparatus according to claim 1, wherein
the strain calculation unit acquires a strain measurement value from a strain sensor, which is for measuring strain in the structure, and determines that the acquired strain measurement value is the strain in the structure when a value of the calculated temperature is not associated with a strain value of the structure in the temperature-versus-strain information.

5: The strain calculation apparatus according to claim 1, further comprising:
a determination unit to determine whether a value of the environmental acquisition data is associated with a temperature value in the environment-versus-temperature information,
wherein the strain calculation unit acquires a strain measurement value from a strain sensor, which is for measuring strain in the structure, and determines that the acquired strain measurement value is the strain in the structure when the determination unit determines that the environmental acquisition data value is not associated with a temperature value.

6: The strain calculation apparatus according to claim 4, further comprising:
a data acquisition unit to control strain measurement performed by the strain sensor,
wherein the data acquisition unit sets, based on a shape of the structure, a measurement location at which the strain sensor measures the strain in the structure, and transmits a flight route including the measurement location to an aerial vehicle that flies while carrying the strain sensor.

7: The strain calculation apparatus according to claim 4, wherein
upon acquiring the strain measurement value, the strain calculation unit further acquires, from a temperature sensor, which is for measuring the temperature of the structure, a temperature measurement value measured when the strain measurement value is acquired, and transmits the strain measurement value and the temperature measurement value to a temperature-versus-strain storage storing the temperature-versus-strain information.

8: The strain calculation apparatus according to claim 7, further comprising:
the temperature-versus-strain storage to store the strain measurement value and the temperature measurement value that are transmitted from the strain calculation unit in a manner associated with each other as the temperature-versus-strain information.

9: The strain calculation apparatus according to claim 1, wherein
the temperature calculation unit calculates the temperature of the structure when a value of the environmental acquisition data is associated with a temperature value in the environment-versus-temperature information.

10: The strain calculation apparatus according to claim 1, wherein
the temperature calculation unit acquires a temperature measurement value from a temperature sensor, which is for measuring the temperature of the structure, and determines that the acquired temperature measurement value is the calculated temperature when a value of the environmental acquisition data is not associated with a temperature value in the environment-versus-temperature information.

11: The strain calculation apparatus according to claim 10, wherein
upon acquiring the temperature measurement value, the temperature calculation unit transmits the environmental acquisition data value and the temperature measurement value to an environment-versus-temperature storage storing the environment-versus-temperature information.

12: The strain calculation apparatus according to claim 11, further comprising:
the environment-versus-temperature storage to store the environmental acquisition data value and the temperature measurement value that are transmitted from the temperature calculation unit in a manner associated with each other as the environment-versus-temperature information.

13: The strain calculation apparatus according to claim 1, wherein
the environment-versus-temperature information is included in an environment-versus-temperature database in which a plurality of values of the environmental data is each associated with a temperature value of the structure acquired when a corresponding one of the environmental data values is acquired.

14: The strain calculation apparatus according to claim 1, wherein
the temperature-versus-strain information is included in a temperature-versus-strain database in which a plurality of temperature values of the structure is each associated with a strain value of the structure at a corresponding one of the temperature values of the structure.

15: The strain calculation apparatus according to claim 1, wherein
in the temperature-versus-strain information a temperature of the structure is associated with a strain in the structure at the temperature by using a function determined by a reference strain value being a strain value of the structure at a reference temperature and a rate of change of strain in the structure with respect to temperature, and the strain calculation unit calculates the strain in the structure by substituting the calculated temperature into the function.

16: The strain calculation apparatus according to claim 15, wherein
the temperature-versus-strain information includes the reference strain and the rate of change that are determined based on a regression analysis on a plurality of temperature values of the structure and strain values of the structure each at a corresponding one of the temperature values of the structure.

17: The strain calculation apparatus according to claim 1, wherein
the structure includes a body and a support movably supporting the body to vary an attitude of the body, and the temperature-versus-strain information corresponds to each attitude of the body.

18: A strain compensation apparatus for compensating for strain in a structure by controlling a strain compensator included in the structure and compensating for the strain in the structure, the strain compensation apparatus comprising:
the strain calculation apparatus according to claim 1; and
a compensator controller to control the strain compensator in accordance with a control variable calculated from a strain value of the structure calculated by the strain calculation unit.

19. (canceled)

20: A non-transitory computer-readable storage medium storing a program for calculating strain in a structure based on environment-versus-temperature information and temperature-versus-strain information, the environment-versus-temperature information associating environmental data being data of an environment affecting a temperature increase or decrease in the structure with a temperature of the structure, the temperature-versus-strain information associating a temperature of the structure with a strain in the structure at the temperature, the program causing the computer to:
calculate a temperature of the structure based on environmental acquisition data representing the environmental data acquired at an installation location of the structure, and the environment-versus-temperature information; and
calculate a strain in the structure based on the calculated temperature of the structure and the temperature-versus-strain information.
